(19) United States
(12) Patent Application Publication
(10) Pub. No.: US 2026/0228750 A1
(43) Pub. Date: Aug. 6, 2026

(54) LARGE LANGUAGE MODEL (LLM) BENCHMARK FOR CUSTOMER RELATIONSHIP MANAGEMENT (CRM)

(71) Applicant: Salesforce, Inc., San Francisco, CA (US)

(72) Inventors: Shafiq Rayhan Joty, Palo Alto, CA (US); Lifu Tu, Palo Alto, CA (US); Peifeng Wang, Palo Alto, CA (US); Bertrand Legrand, Palo Alto, CA (US); Sarah Tan, Seattle, WA (US); Casey O'Donnell, Seattle, WA (US); James Bowen, Seattle, WA (US)

(21) Appl. No.: 19/042,826

(22) Filed: Jan. 31, 2025

(51) Int. Cl. G06Q 30/015; G06Q 30/0201; G06F 40/40

(52) U.S. Cl. CPC G06Q 30/015; G06Q 30/02015; G06Q 30/0206; G06F 40/40

(57) ABSTRACT

Techniques for generating benchmarks for evaluating a set of LLMs for use cases are provided. The method includes receiving at least one data set associated with at least one use case. In response to detection of a grounded prompt of a selected element associated with a use case, identifying, using an algorithm, a set of LLMs that are applicable to the use case. Then, configuring a benchmark associated with a set of LLMs to evaluate each LLM and displaying in a Graphical User Interface (GUI) a listing of the LLMs in accordance with an evaluation based on the benchmark, further, ordering a set of LLMs in the GUI based on a selection of a selectable element configured in the GUI wherein the selectable element is mapped with a benchmark to identify an LLM that is suitable for the use case.

### RELATED APPLICATION(S)

The present U.S. Non-provisional Patent Application is related to U.S Non-provisional Patent Application having the title “LARGE LANGUAGE MODEL (LLM) BENCHMARK FOR CUSTOMER RELATIONSHIP MANAGEMENT (CRM)”, Serial No. XX/XXX,XXX filed January 31, 2025, U.S Non-provisional Patent Application having the title “LARGE LANGUAGE MODEL (LLM) BENCHMARKS FOR ARTIFICIAL INTELLIGENT (AI) AGENTS USE CASES IN A CUSTOMER RELATIONSHIP MANAGEMENT (CRM) ENVIRONMENT”, Serial No. XX/XXX,XXX filed January 31, 2025, and U.S. Patent Design Patent Application filed January 31, 2025, Serial No. XX/XXX,XXX. The entire contents of the related filed U.S. Patent Applications are hereby incorporated by reference into the present patent application.

### TECHNICAL FIELD

Artificial Intelligence (AI) has transformed Customer Relationship Management (CRM) from a simple data management system into a dynamic engine that delivers actionable insights to users. By leveraging machine learning algorithms, natural language processing (NLP), and predictive analytics, AI can process vast amounts of historical data to identify patterns, forecast trends, and predict customer behavior. This capability empowers businesses to enhance customer satisfaction, improve retention rates, and optimize marketing investments when selecting AI models.

AI models are increasingly deployed in high-stakes environments, making it essential to assess their capabilities and associated risks rigorously. Benchmarks have become a widely used tool for evaluating these attributes, comparing model performance, tracking advancements, and identifying weaknesses in both foundation and non-foundation models. They play a crucial role in guiding model selection for downstream tasks and shaping policy decisions. However, not all benchmarks are created equal—their effectiveness depends heavily on their design and usability.

Existing benchmarks for generative AI are primarily academic, often lacking relevance to real-world use cases and failing to incorporate actual business data. As a result, they offer limited value to businesses seeking to understand the practical capabilities of generative AI. Even when results appear relevant, they can be unreliable, as evaluations are frequently conducted by Large Language Models (LLMs) rather than actual users. Moreover, these benchmarks typically fail to provide key business metrics—such as cost, speed, and trust and safety—in a comprehensive view. Without insights into costs, for example, it becomes nearly impossible for businesses to assess the Return On Investment (ROI) accurately.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example environment for performing techniques described herein.

FIG. 2 illustrates an exemplary diagram of elements of a judge model for accuracy in accordance with examples of the present disclosure.

FIG. 3 illustrates an exemplary diagram for aspects of the trust and safety metric calculation of a generated response to a query according to some examples.

FIG. 4 illustrates an exemplary table of two data sets that are constructed to determine cost and speed calculations according to some examples.

FIG. 5 illustrates an exemplary diagram of an auto-evaluation process of the evaluation system in accordance with some examples.

FIG. 6 illustrates an exemplary table of 11 use cases and their corresponding cost and speed according to some examples.

FIG. 7 illustrates an exemplary table of approximately 15 LLMs for evaluating a set of CRM use cases according to some examples.

FIG. 8 illustrates an exemplary table of various judge models to agreements in various datasets according to some examples.

FIG. 9 illustrates an example component configuration of an evaluation platform for performing techniques described herein.

FIG. 10 is a flow diagram illustrating an example process for evaluating one or more models for use cases according to examples.

FIG. 11 illustrates an example system for performing techniques described herein.

FIG. 12 illustrates a user interface configured for filtering the type of use case and selecting various metrics to rank suitable LLMs based on some examples.

FIGS. 13A and 13B are flow diagrams illustrating an example process for evaluating one or more models for use cases according to examples.

### DETAILED DESCRIPTION

To successfully adopt Artificial Intelligence (AI), organizations often require that in the decision-making process, to make determinations of particular Large Language Models (LLMs) based on prioritizing a use case and selecting the appropriate LLM for an organization’s needs. That is, some organizations prioritize Return on Investment (ROI), which can be driven by efficiency and value generation, and choosing an LLM that is accurate, fast, trustworthy, and cost-effective enough to support the required ROI. A number of factors must be considered when selecting an LLM, as some LLMs can be significantly more expensive than others and not as suitable for a particular task, which affects business choices.

Benchmarks for Generative Artificial Intelligence (AI) models are useful, if not crucial, tools in the development of more advanced and versatile AI systems and making business choices when selecting an LLM amongst a set of available LLMs. For example, a set of benchmarks that are AI-generated can assist a user in comparing and weighing different models' attributes, such as the model's abilities to understand, reason, and adapt across various domains. Judging or evaluating large language models (LLMs) is complex and often not straightforward. It can often involve a multi-faceted approach that may require examining their performance across various dimensions such as evaluation metrics, qualitative assessment, task-specific evaluations, manually configured benchmarks, computational efficiency, and domain-specific integrations.

Techniques for evaluating Large Language Models (LLMS) may include using at least actual or real-world data and providing associated business metrics such as costs, speed, trust, and safety associated with each business model are described herein. In some examples, a Graphical User Interface (GUI) or a UI may be displayed that includes static data and dynamic data that enables the comparison of more than one LLM model with other LLM models in different scenarios and business uses for identifying the most appropriate or suitable LLM model to be used for a particular business application.

In some examples, the techniques for evaluating LLMs may use synthetic data and/or actual (e.g., real-world) data or a combination of both that is inputted to one or more LLM models for evaluating attributes in the processing of the input data by each LLM.

In some examples, to assist in user valuations of multiple LLMs, there can be a need to establish evaluation metrics tailored to generative AI models designed for specific tasks or domains. Herein, techniques are described for synchronizing the display and adjustment of multiple criteria to facilitate the display for convenient visual comparisons of different LLMs across various use cases.

In some examples, evaluation systems and methods are provided for a set of LLMs that enable a metric-based evaluation methodology for various and different LLM models. In an example, a Model (e.g., Judge Model) is configured for reporting and generating use case evaluations based on user selection of metric criteria. As an example, an LLM Judge may be configured based on a next-generation Meta Llama model, such as a Llama 3-70b model specially tasked to act as a reliable, intelligent referee for other models’ responses.

In some examples, multiple use cases are configured for evaluating one or more LLMs by evaluation systems and methods for a set of selected and/or available LLMs. In instances, each use case is configured or based on aggregated use case data applied or used by one or more LLM models that are subsequently displayed in a listing for visual comparison of certain attributes. In one example, a process may be provided for application by the LLM evaluation system and methods using an LLM judge (i.e., using a module configured for LLM judge operations) for evaluating a plurality of LLM models for a plurality of use cases. For example, by assessing a plurality of quantities such as accuracy, cost, speed, trust, and safety with selected criteria for each LLM model by comparisons of each LLM model with aggregated use data and the selected criteria using a scoring tool. The evaluation of each LLM model may be automatically performed using different language models.

In some examples, a metric of accuracy (often considered a primary metric for evaluating an LLM) may include or encompass four key aspects that include the sub metrics of factuality, completeness, conciseness, and instruction-following. Accurate predictions and recommendations may result by effectively making determinations of the various sub-metrics described. They may also provide valuable insights for one or more users across a network or an organization, enabling better decision-making to enhance the customer experience. While achieving a high level of accuracy is important, it may be deemed that it is equally critical to evaluate other metrics. For use cases where accuracy falls short, strategies like prompt engineering and fine-tuning can be employed to improve outcomes.

In some examples, the cost may include a cost metric, which can be or is classified into high, medium, and low categories based on percentiles, representing the estimated operational cost for different CRM use cases to examine LLM performance. The resultant outputs of performance metrics may allow organizations to determine which metric or metrics are of more value and subsequently to better evaluate aspects of the LLM, such as the cost-effectiveness of various LLMs, thus ensuring alignment of a selected LLM for use with an organization budget and resource allocation strategies.

In some examples, the organization may weigh one or metrics differently to make value determinations of one or more LLMs. For example, a metric of speed or latency may be used to evaluate an LLM's responsiveness and efficiency in processing and delivering information. The organization's rationale may be that a faster response time of an LLM may materially enhance the user experience, minimize customer wait times, empower sales and service teams to address inquiries, and resolve issues more efficiently.

In some examples, an organization may weigh a metric based on the trust and safety of an LLM. In this instance, the organization may use this metric to determine or assess an LLM's ability to safeguard sensitive customer data, comply with data privacy regulations, maintain information security, and avoid bias or toxicity in CRM applications. By providing insights into an LLM's reliability, different sets of benchmarks help or assist an organization to ensure transparency and confidence in the trust and safety performance of a selected LLM.

In some examples, systems and methods are provided for a multi-prong or a 2-prong approach for evaluating and assessing the performance of various generative AI models across different domains. For instance, the first prong of the approach may use a strictly automated evaluation process. The automated evaluation process may have limitations, constraints, and/or deficiencies when applied to determinations that cannot be easily quantified. To address such challenges, a second prong of the approach may be integrated that includes a manual step. That is, the manual process may be incorporated or integrated with the automated evaluation process when necessary, which may cause an increase in the accuracy of automated evaluation processes.

In some examples, model evaluation systems and methods are described that are configured to enable a process to generate a plurality of evaluation metrics for visual display in a graphical user interface (GUI) for selection, to receive at least one evaluation metric selected from the plurality of evaluation metrics, and to apply a scoring tool based on at least one evaluation metric. Further, the process may be identified by using an algorithm to allow the determination of one or more LLMs from a list of LLM modules that meet criteria based on aggregated use case data applied to each LLM compared to the selected evaluation metric; prioritize, by the algorithm, one or more LLM models which have been determined based on the aggregate use case data and the chosen evaluation metric; and display in a graphical interface one or more LLM models in accordance with a priority and output from the scoring tool for visual identification of an LLM for use in a particular use case. The plurality of evaluation metrics comprises at least one metric associated with cost, speed, trust. or safety, and the evaluating step comprises both an automatic and a manual evaluation process.

When managing data about one or more LLM models within an evaluation platform (or workspace), it may be beneficial to leverage and/or use data from various LLMs based on sales and service use cases across a plurality of attributes that consist of accuracy, cost, speed, and trust and safety use cases, based in part on real or actual CRM data. For example, past data derived from extensive internal manual evaluations may be accessed in an evaluation platform for a comprehensive but dynamically configured list of LLMs associated with respective use cases. In instances when it is necessary to scale the evaluation data and maintain a cost-effective automated evaluation, methods may be applied based on one or more LLM judges. For example, an LLM judge is an application configured to evaluate and make assessments on specific inputs based on predefined criteria or contextual understanding (e.g., an intelligent evaluator that provides judgments and scorings on tasks requiring complex reasoning).

In some examples, one or more benchmarks are presented by the LLM evaluation platform via an interactive dashboard or leaderboard. For example, the interactive dashboard may be configured as a TABLEAU® dashboard and/or using a collaborative platform for displaying the leaderboard, such as HUGGING FACE®. In some examples, by user selection, different modeling of one or more attributes associated with each LLM may be performed to produce different modeled results. For example, LLMs may be filtered and presented in a list with side-by-side views of criteria to be weighed and selected based on one or more selectable items. In an instance, to make a selection for an LLM by a user interested in improving a sales department, the user may first establish threshold criteria and then proceed in making tradeoffs to revise the initial listing of LLMs based on various metrics such as accuracy, cost, and trust and safety. For example, the user may initially weigh accuracy more and then determine that a particular set of models is deemed sufficiently accurate. Then, drilling down on the list based on one or more of the other metrics results in a further reordering of the list for a different weighting of the list of LLM, enabling a different and/or enhanced contextual visual depiction and subsequent understanding of the user of a more appropriate or more suitable LLM for the particular use case.

In some examples, the evaluation platform may utilize real-world data sets from both customers and proprietary internal operations. The data sets are then processed through an automated pipeline, which handles tasks like automated evaluation, cost analysis, performance speed assessments, and trust and safety checks. Beyond these automated processes, the evaluation platform also incorporates outputs from LLMs. It may also rely on subject matter experts to conduct manual evaluations of outputs for processing by the LLMs. In some instances, multiple entities may be involved in the manual evaluation process to enhance the reliability of the data inputted into each language model. For instance, if there is a disagreement in an evaluation between more than one evaluator, the data may be discarded as its reliability may prove to be deficient. Hence, both an automated and a semi-automated approach is formulated to enhance the reliability of the data inputted into each language model without impinging or causing bottlenecks in the processing of the data being inputted to each LLM. In some examples, a set of four metrics is utilized in which the established framework leverages a symmetrical structure, which simplifies conceptual understanding. Four distinct metrics are used, each measured on a four-point scale but with clearly differentiated meanings, thereby ensuring these metrics are mutually exclusive.

By incorporating this manual intervention into an otherwise automated process to adjust the weighting of one or more metrics, model selection becomes more than merely choosing the most accurate option. Instead, it involves blending additional metrics and criteria into the decision-making process to determine the most suitable overall fit. The number of models presented in the graphical user interface (GUI) for user selection can be increased or decreased based on the likelihood of use and selection for each use case. Each of the models for a particular use case has been tested with use case data that is dynamically uploaded and inputted to each model to enable model evaluations and applicability. Hence, each model has already been provisioned with appropriate use case data, and computed values for each model in the various metrics have already been processed so that latency time for the user selection of metrics and model determination is reduced and made possible on demand or instantaneously.

In some examples, in the case of selecting an AI agent, one or more unique and/or tailored agent datasets are leveraged in algorithmic calculations with several focuses being considered, including a likely primary focus on the accuracy of topic classification. For example, for this metric, an agent-driven construct is built that evaluates how effectively an agent identifies the subject matter of a conversation. It is deemed a critical function when the agent engages autonomously and even converses with itself.

In some examples, for an Artificial Intelligent (AI) agent, one or more sub-metrics are aggregated for a set of about agent accuracy that are made of at least three individual sub-metrics. In an example, the three metrics may include a first metric, which is topic accuracy, and a second metric, which evaluates the correctness of function calls made by the LLM. This is essentially checking if the agent calls the right function with the appropriate parameters. For example, a call operation may include an agent being instructed to send an email to a customer or execute another predefined action, and the checking would determine if, in fact, this was the right action to be initiated by the agent. In the example, the third metric focuses on the AI agent model’s response to the user. This evaluation is likely a more intricate determination because, in a large language model, the agent’s replies can vary in wording while still conveying the same meaning. Therefore, a correct response would be configured to consider different variations that may be valid as long as the core intent and information remain consistent.

In some examples, the processes described for evaluating LLMs and for selecting an appropriate LLM may include applying Retrieval Augmented Generation (RAG) to automatically embed the most current and relevant proprietary data directly into their LLM prompt; this may include retrieving all or nearly all available data, including unstructured data: emails, PDFs, chat logs, social media posts, and other types of information that can lead to a better AI output.

In some examples, the evaluation systems and methods generate one or more benchmarks that can be considered a living tool that is continually updated with more use cases across more clouds, more manual evaluations, more LLMs, including fine-tuned LLMs and small LLMs (e.g., under 4 billion parameters); and context windows, which define how much information a model can take on.

In some examples, a CRM benchmark framework is configured to identify an enhanced solution for the particular needs of an organization and make informed decisions, balancing accuracy, cost, speed, trust, and safety. As an example, SALESFORCE® Einstein platform can provide users the ability to choose from existing LLMs or enable unique users to be generated to meet particular business requirements. By selecting models for their CRM use cases using the benchmark, businesses can deploy more effective and efficient regenerative AI solutions.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized, and changes can be made without departing from the scope of the disclosure. The following detailed description is, therefore, not to be taken in a limiting sense. The scope of the disclosure is defined only by the appended claims, along with the full scope of equivalents to which such claims are entitled.

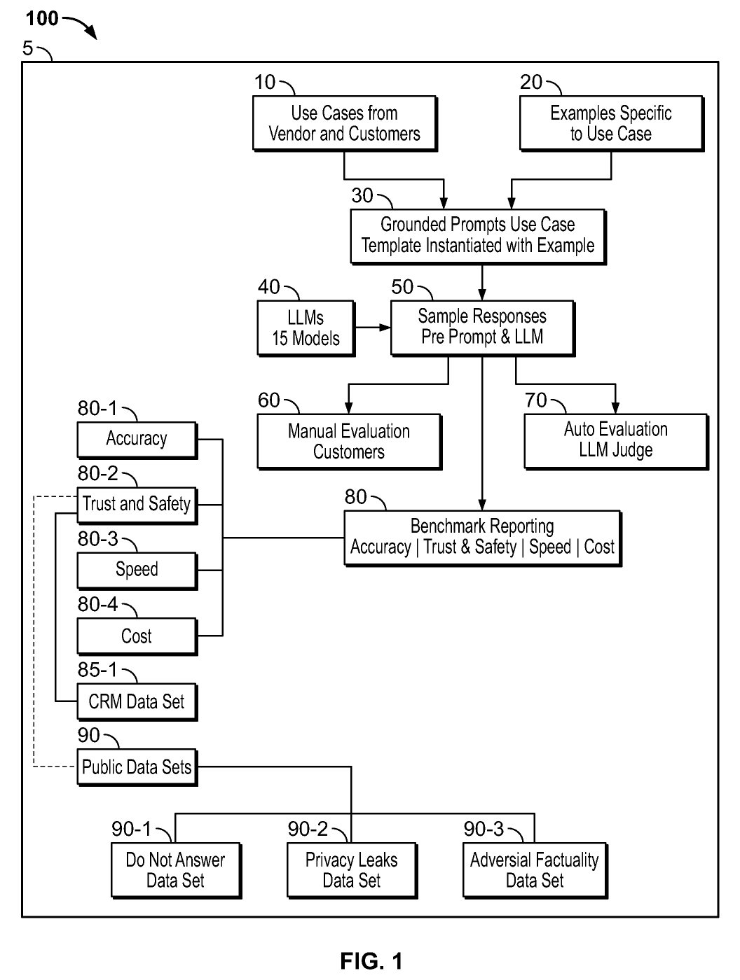

FIG. 1 illustrates an example environment 100 for performing techniques described herein. The example environment 100 for evaluating Large Language Models against diverse benchmarks and real-world scenarios overcomes significant technological problems. For example, Conventional model-evaluation pipelines often require extensive processing cycles. Evaluating large models against large test datasets can saturate CPU/GPU resources, leading to slower feedback loops. Also, traditional model evaluation processes may include brute-force approaches to testing LLMs that can introduce significant latency in obtaining evaluation results—particularly in distributed or cloud-based environments. Further, model evaluations may rely on frequent data transfers between remote servers and local environments that can quickly overload network bandwidth, causing delays and potential data losses. Storing multiple versions of large models, as well as large benchmark datasets, can exceed on-premises or cloud storage limits, incurring substantial costs and logistical hurdles. Because of these challenges, there is a pressing need for a more efficient and standardized system for evaluating LLMs as employed in the example environment 100 by enabling means to measure the accuracy and robustness of models while also reducing the technical burdens—computing, networking, and storage—that such evaluations can often impose.

In at least one example, the example environment 100 can be associated with an evaluation platform 5 that can leverage a network-based computing system to enable users of the evaluation platform to evaluate a number of Large-Scale Models (LLMs) 112 to exchange data. FIG. 1 in the example environment 100 includes a set of data elements that, in at least one example, may include use cases 10 from customers and internal data; some examples 20 that are specific to one or more of the use cases 10; one or more ground prompts 30 that may include use case templates instantiated with one or more examples; a set of previously configured LLM models 40 for selections and prioritizing for particular use cases; sample response 50 that are instantiated per prompts and LLMs. Also included is a manual evaluation process 60 using subject matter experts to qualify the data and responses, an automated evaluation process 70 using one or more LLM judges, and a benchmark reporting 80 consisting of a number of items including accuracy 80-1, trust and safety 80-2, speed 80-3 and cost 80-4 that are subject to manual user selection and manipulation weighing tradeoffs between each of the items in an LLM selection and prioritizing in a listing of a set of LLM for a use case.

In at least one example, the example environment 100 (shown diagrammatically in FIG. 1) is associated with an evaluation platform 5 that leverages a network-based computing system to enable users to evaluate multiple Large-Scale Language Models (LLMs) 112 and exchange data. The Environment 100 can be deployed on-premises, in the cloud (public or private), or in a hybrid setup and is configured to reduce computational overhead, storage costs, and latency through modular pipelines, caching, and intelligent model selection. Within environment 100, various data elements support the evaluation process: Use Cases 10, drawing on customer or internal data and specifying functional requirements and performance constraints; Examples 20, which are curated inputs (often domain-specific and tagged for complexity) used to instantiate Ground Prompts 30 that merge templates with contextual information (like user settings or conversation history). A set of Preconfigured LLM Models 40, stored in a version-controlled repository, can be prioritized based on performance or compliance and dynamically allocated for inference. For each prompt, Sample Responses 50 are generated, automatically logged and managed in an indexed datastore, with fallback mechanisms if a model times out. A Manual Evaluation Process 60 uses subject matter experts to judge correctness and relevance qualitatively. In contrast, an Automated Evaluation Process 70 employs specialized LLMs or rule-based engines to score or classify responses according to metrics such as BLEU or ROUGE, as well as trust and safety criteria. Finally, a Benchmark Reporting 80 module collates results on accuracy (80-1), trust and safety (80-2), speed (80-3), and cost (80-4), enabling users to manipulate and weigh tradeoffs among these metrics and produce a customized ranking of LLMs for a given use case.

In some examples, evaluation platform 5 may leverage a network-based computing system to enable users to evaluate multiple Large-Scale Language Models (LLMs) 112 and exchange data within the platform. The Environment 100 may be deployed across on-premises servers, cloud infrastructure (public or private), or a hybrid model. The environment 100 is configured to reduce computational overhead, storage costs, and latency by employing modular evaluation pipelines, caching, and intelligent model selection.

In some examples, one or more of a set of data elements in environment 100 may include Use Cases 10 of Customer and Internal Data Sources. For example, a use case 10 may include data elements that are data on enterprise-specific tasks, domain-oriented corpora, or typical consumer-oriented scenarios. Each use case 10 can define functional requirements (e.g., summarization vs. classification) and performance constraints (e.g., desired response time, accuracy thresholds).

In an embodiment, for example, the example 20 may be derived from or based on the Use Case 10. The use cases 10 may include various sets of example inputs representative of real-world queries or tasks. For example, domain-specific samples may be used in use cases 10. Also, example 20 may be specialized for particular industries (e.g., finance, healthcare) or general-purpose language tasks. Metadata-Driven Tagging: Each example can be tagged with complexity level, domain category, expected output type, etc., enabling adaptive routing in the evaluation pipeline.

In some examples, Ground Prompts 30 Template-Based Prompt Instantiation may include or be configured to be predefined templates that dynamically insert one or more of the Examples 20 to form fully qualified prompts. Also included can be contextual embedding which may include additional contexts such as user settings, conversation history, or policy constraints. Various Prompt Variations and Parameterization may also be configured with the Ground Prompts 30. For example, Ground Prompts 30 can be versioned or parameterized to test specific behaviors of each LLM (e.g., “temperature” settings, response length constraints).

In some examples, preconfigured LLMs 40 may be stored and retrieved from Model Repositories. The Model Repositories may include databases, multi-tenant storage repositories, or databases that are configured as a version-controlled repository (e.g., a model registry), which tracks architectural differences, training data lineage, and hyperparameters. In instances, along with these storage facilities, a selection and prioritization Mechanism may be employed. For example, a selection logic may be used that identifies which models are to be prioritized for a given use case based on performance profiles, compliance requirements, or user-defined criteria (e.g., cost sensitivity, speed, or domain fit). Dynamic Allocation: The evaluation platform 5 may also be configured to dynamically spin up or allocate computing resources (e.g., GPU clusters) to load and test these models.

In some examples, various sample responses 50, such as an instantiation per Prompt/Model Pair, may be employed. For example, for each ground prompt 30, one or more of the LLMs in the preconfigured model set 40 may be configured to generate a response. In some instances, an automated logging and tracking mechanism may be used. For example, platform 5 may be configured to automatically store generated responses in an indexed datastore, linking them to the corresponding prompt and model version. Error-handling and fallback default mechanisms may also be employed with the instantiation discussed. For example, a particular scenario may include if a model fails to generate a response within the specified timeout, a fallback or partial output may be logged for diagnostic purposes.

In some examples, the Manual Evaluation Process 60 may be configured to include a Human-in-the-Loop Assessment that comprises subject matter experts (SMEs) or end-users evaluating the correctness, relevance, and completeness of Sample Responses 50. In an example manual intervention process, a subject matter expert of another end-user may review and provide qualitative feedback that is captured with the data associated with the model rating. For example, manual input may adjust ratings or annotations that are associated with each response, aiding in refining future prompts or model tuning.

To increase the scalability aspects of the manual review, the SMEs can be geographically allocated or distributed to allow for the review of disparate site-based responses. For example, a web-based interface or collaboration tool can be implemented with each manual review being performed to enable parallel/manual review at scale based on similar annotations being performed. Also, to make up for the inability to scale the manual review process efficiently, an Automated Evaluation Process 70 using LLM-Based Judges may be implemented. For example, the automated evaluation process 70 may be configured to utilize one or more specialized LLMs or rule-based engines to automatically score or classify Sample Responses 50 for correctness, compliance, style, etc. Multi-Metric Analysis: This automated review process may also be configured to compute metrics or sub-metrics such as ROUGE, BLEU, or domain-specific accuracy. Additional checks for policy compliance, toxicity, or bias may also be applied.

In some examples, an iterative feedback loop may be configured for both the manual and automated processes. For example, one or more sets of scores from the automated evaluation process 70 can feed directly into model refinement pipelines (e.g., active learning or reinforcement learning from human feedback (RLHF)) for multiple levels of refinement. The iterative feedback loop may also be implemented with the various metrics for further dynamic refinements. In some examples, the various Benchmark Reporting 80 Evaluation Metrics (80-1 – 80-4) may be configured to include the metrics of Accuracy (80-1), which may integrate or includes standard NLP metrics and domain-specific performance indicators; the Trust and Safety (80-2) may be used to measure adherence to content guidelines, potential toxicity, and safety compliance; speed (80-3): Track average latency or throughput under specified hardware configurations and cost (80-4): perform estimates or calculate the compute costs (e.g., GPU-hour usage), enabling cost/performance tradeoff analysis. By using the Manual User Selection and Manipulation, users can weigh tradeoffs between items (e.g., prioritizing lower latency over slightly reduced accuracy) for a custom LLM ranking.

In some examples, an LLM selection and prioritization of an output may be considered. For example, a final step may be configured to generate a listing or ranking of candidate LLMs best suited for a given use case, possibly including explanations or confidence scores. In some instants, operations of the Evaluation Platform 5 may be optimized. For example, techniques for Network-Based Computing System Integration that include Cloud-Native Orchestration may be implemented. As an example, the evaluation platform 5 may be configured to be containerized and deployed on orchestration frameworks (e.g., Kubernetes) to dynamically scale the number of inference instances, especially for parallel or large-scale benchmarking tasks. Also, techniques such as load balancing that optimize the system by automatically enabling routes prompt requests to different LLM instances, balancing compute usage and ensuring robust performance under varying workloads can be applied.

Other techniques that may be implemented in the system include data exchange Mechanisms. For example, use of APIs and Webhooks in the evaluation platform 5 may expose REST or GraphQL endpoints for external systems to submit new examples or retrieve aggregated benchmark reports. For security, secure Transmission techniques can be used that include securing data exchanges, particularly model responses and user prompts can be encrypted to adhere to data-protection requirements (e.g., TLS, HTTPS, or VPN tunnels). In some examples, caching and storage optimization techniques may be used in the system. For example, an intermediate storage may be used for generated sample responses 50 and partially processed prompts may be cached in memory (e.g., Redis) or on disk for rapid re-retrieval and to reduce redundant computations. In some examples, version control techniques for the system may be employed. For example, each artifact (prompt template, model checkpoint, manual evaluation rating) may be assigned a unique version ID, enabling precise rollback and reproducibility for audits or repeated experiments. In some examples, an evaluation workflow data ingestion and prompt generation may be configured. For example, the evaluation platform 5 may be configured to receive a new set of use cases 10 from a customer, with relevant Examples 20.

In some examples, the system may be configured to instantiate Ground Prompts 30 by embedding Examples 20 into domain-specific templates, generating a variety of prompt permutations for stress testing each LLM. In an example, the LLM selection and response generation operations within the platform 5 may be determined based on queries of a set of preconfigured LLM models 40 that are determined to identify which LLMs meet the user’s criteria (e.g., top-3 models for healthcare compliance). For each prompt, Sample Responses 50 are generated and stored, annotated with attributes such as a model ID, timestamp, and performance metadata (e.g., token usage, latency).

In some examples, the evaluation and scoring for Manual Evaluation 60 can include a set of human reviewers that conduct a targeted review of the new or critical prompts so as to provide qualitative feedback on correctness or style. In contrast, the automated evaluation 70 may be configured to implement LLM-based or rule-based scoring engines to analyze all or nearly all of the Sample Responses 50 to compute accuracy, detect policy violations, and measure latency. The results of these evaluations may then be quantified in a Benchmark Reporting and Model Ranking. In some examples, the Benchmark Reporting 80 consolidates various sets of metrics (80-1: Accuracy, 80-2: Trust and Safety, 80-3: Speed, 80-4: Cost) so that one or more suitable LLM models can be identified. In an example, one or more users interact with a dashboard or UI to dynamically adjust (or toggle) weights for each metric, generating a prioritized list of LLMs that changes based on the adjustments of the weights and the use case data, and that optimize the user’s preferences (e.g., highest trust and safety with minimal cost).

In some examples, the system is configured in a manner that provides for technical advantages with reduced computation cycles through a modular architecture and partial re-evaluation strategies. That is platform 5 avoids re-running entire benchmarks if only a subset of prompts or models changes. This reduction in processing is performed in part by caching certain intermediate results that can eliminate repetitive calculations, cutting down CPU/GPU usage. Hence, using Low Latency Distributed orchestration with horizontal scaling ensures a high degree of parallelization with techniques such as real-time caching of frequent prompts and model states reduces inference time, improving responsiveness for interactive evaluations.

In some examples, optimized Network Bandwidth and On-Demand Data Streaming techniques may be implemented with the system. For example, the system may be configured only to retrieve relevant data slices for each use case, preventing bulk transfer of entire datasets. In some examples, compression Algorithms may be used. For example, the system may use such compressed algorithms for text-based data to foster bandwidth conservation when transferring large prompt sets or storing historical responses. In some examples, efficient storage management versioned model artifacts may be implemented. For example, the system may be configured to automatically prune unused or obsolete model versions, retaining only essential checkpoints linked to currently active use cases. In some examples, the system may use delta-based evaluation artifacts for efficient processing in which the system stores only the differences or incremental changes in ground prompts or example sets, drastically reducing disk usage. In some examples, scalable and flexible architecture solutions may be used to support various LLMs. For example, the evaluation platform may be configured to integrate both open-source and proprietary models, enabling broad applicability across multiple domains and extensibility for Future Benchmarks. That is, additions of new benchmarks (e.g., specialized domain tasks) may be configured with requiring only minimal configuration updates to the existing pipeline.

As discussed, the disclosed evaluation platform 5 (shown in FIG. 1 as part of the example environment 100) systematically addresses the technological problem of evaluating large-scale language models in a resource-intensive, time-consuming, and often siloed manner. By providing use cases 10, examples 20, ground prompts 30, LLM models 40, sample responses 50, manual and automated evaluation processes (60, 70), and benchmark reporting 80, the system ensures technical gains in computational efficiency, reduced latency through distributed orchestration and caching, minimized network overhead via intelligent data streaming, and optimized storage footprints by eliminating redundancy in model checkpoints and evaluation artifacts. Users benefit from a customizable and scalable system that balances accuracy, trust and safety, speed, and cost—ultimately accelerating the iterative cycle of development, testing, and deployment for large-scale language models.

### Benchmark

In at least one example, for the benchmark reporting 80, the item of accuracy 80-1 of one or more outputs from LLMs based on several aspects may include the following sub-items to calculate: factuality 85-1, to examine whether the response is valid, and free of misinformation; instruction following 85-2, which evaluates adherence to the requested format and content; conciseness 85-3, which checks that the answer is both direct and avoids unnecessary elaboration; and completeness, which ensures that all relevant information is included. In some examples, a scale is configured to determine the completeness of a response. For evaluation, a four-point scoring rubric may be used in which a four-point score is indicative of a very good response requiring minimal improvement, a three-point score may represent a generally good response with some room for refinement, a two-score may denote a poor, essentially unusable response, and one point score may signify an inferior outcome with critical issues. However, while a four-point rubric is described it is contemplated that a variety of other of different scoring methodologies may be used.

In the benchmark reporting 80, for determination of trust and safety 80-2, a two-pronged process may be used that includes, initially, accessing multiple public datasets that include accessing public datasets 90 of a first, second, and third data set respectively for Safety, Privacy, and Truthfulness. For example, a Do Not Answer dataset 90-1 may be used to gauge Safety, which is calculated by measuring as 100 minus the percentage of times a model refuses to answer an unsafe prompt. For privacy, a Privacy Leakage dataset 90-2 may be used for the evaluation. The calculations for privacy reflect the average percentage of prompts where privacy is maintained (e.g., avoiding disclosure of personal email addresses) across both zero-shot and five-shot settings. Truthfulness is measured with the Adversarial Factuality dataset 90-3 as the percentage of instances in which the model correctly addresses misleading or incorrect factual prompts.

In some examples, for the second prong, CRM Fairness is evaluated by introducing perturbations to the CRM datasets 85-1. CRM fairness may involve altering either person names and pronouns to measure gender bias or company/account names to measure account bias. Each type of bias is defined as the change in model performance after these perturbations, and the overall CRM Fairness score is the average of gender bias and account bias. To enhance the robustness of this measure, five perturbed versions for each bias type and use bootstrapping to estimate the distribution of performance changes, computing 95% confidence intervals to confirm the statistical significance of rankings beyond the first place.

In some examples, Safety, Privacy, Truthfulness, and CRM Fairness are aggregated into a single Trust and Safety 80-2 measure, expressed as a percentage. Future iterations of the CRM benchmark will incorporate additional metrics to provide an even more comprehensive assessment.

In the benchmark reporting 80, for cost 80-4 and speed (latency) 80-3 there may be configured or created two separate prompt datasets to evaluate cost 80-4 and latency 80-3. In an example, each dataset is configured to consist of prompts approximately 500 tokens and 3,000 tokens in length, representing typical prompt sizes for generation and summarization tasks, respectively. In the example, for the cost calculation, each of the prompts is configured to yield outputs of at least 250 tokens. For example, by asking or requesting an LLM (a model) to copy the entire input with a setting of a maximum output length of 250 tokens that mirrors the typical output size for both summarization and generation, the Latency 80-3 is measured as the average time taken to produce the full completion across these datasets. For externally hosted APIs, either directly provided by the LLM provider or through AMAZON WEB SERVICES (“AWS”) Bedrock (or GOOGLE® Vertex, MICROSOFT® Azure, or other services that process access to pre-trained AI models), the costs 80-4 may be computed using the standard per-token pricing. For the in-house xGen-22B model, latency is 80-3, and costs 80-4 may be estimated using proxy models of 12B and 52B parameters on Bedrock.

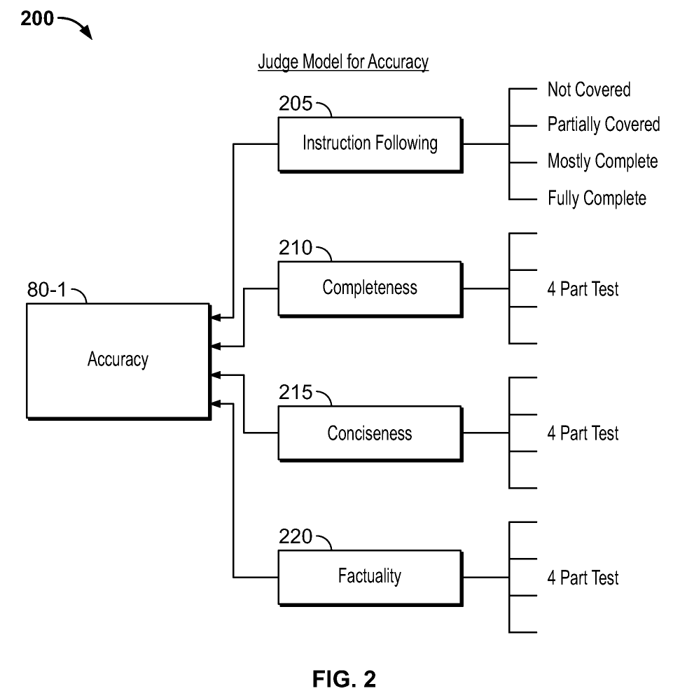

FIG. 2 illustrates an exemplary diagram 200 of elements of a judge model for accuracy in accordance with examples of the present disclosure. FIG. 2. In some examples, the accuracy in FIG. 2 is intended to represent how well each model performs relative to the specific use case or prompt that was inputted. In other words, it measures how effectively a model responds to the given instructions and meets the criteria of the request. Components such as instruction following (i.e., adhering to the exact request or directive), completeness (covering all necessary details and requirements), and other evaluative factors (e.g., relevance, clarity) serve as sub-metrics or contributors to the overall accuracy score. Essentially, these components help break down different aspects of “accuracy” so that evaluators can see why a particular model response is deemed more or less accurate according to the specified standards or objectives. The accuracy 80-1 of the benchmark reporting 80 of FIG. 1 may be evaluated using information derived from contextual information about a model evaluation of elements of instruction-following 205, completeness 210, conciseness 215, and factuality 220 of outputted information. For example, with respect to the instruction-following 205, the system is given some context, a query, and a response generated by another AI assistant. The task is to rate the instruction-following 205 aspects of the generated response with a score that may be configured in a point scale or other scoring methodology.

In some examples, the system may assess relevance through a combination of automated checks and, in some cases, human-in-the-loop verification. First, it analyzes the semantic alignment between the user’s query and the model’s generated response—often by applying embedding-based similarity scores or topic-matching algorithms to identify how closely the response content aligns with the requested information. If the system detects phrases, entities, or entire segments of text that fall outside the scope of the original query, it flags them as potentially irrelevant.

In some examples, as an alternate methodology, rule-based filters may be employed to watch for out-of-scope content (e.g., known forbidden topics or domain-specific constraints). In more advanced setups, an LLM-based “judge” is used to evaluate text for extraneous material, comparing the response to the original prompt and referencing any ground-truth examples or style guides. Finally, in a manual evaluation phase, human subject matter experts can review flagged content to confirm whether it indeed introduces irrelevant or off-topic details. This multi-layered approach ensures that the system can identify and penalize unnecessary information, thereby improving overall response relevance.

For example, in a stepwise score of one to four, the generated response will be scored based on whether the generated response only contains information relevant to the query and directly and appropriately addresses the query. Depending on the result, a score will be generated, in this case, from one to four.

For example, a point score may be given for a first scenario in which there is No Instruction Following; in this case, the generated response does not address or failed to address or determine the query whatsoever. In other words, it contains information that is entirely irrelevant to the query and does not follow the instructions that had been requested. In another instance or second case, a different score may be given for a partial instruction following. In this case, the generated response addresses the query to some extent but includes significant irrelevant information or misses key aspects of the query. It follows the instructions partially. In another instance or third case, a likely higher score may be given when the instruction is mainly followed. In this case, The generated response broadly addresses the query and contains relevant primary information. It may miss minor aspects of the query or include slightly irrelevant information, but it mostly follows the instructions.

In another instance or a fourth case, an even higher score may be given if the instruction is thoroughly followed. The generated response directly and appropriately addresses the query. It contains only relevant information and follows the instructions thoroughly.

This scoring system is additive in the sense that a response starts at Score 1 and can earn additional points as it becomes more relevant and aligns more closely with the query.

In some examples, with respect to completeness 210, the system is given some context, a query, and a response generated by another AI assistant. For example, completeness 210 may refer to the extent to which a response—or set of responses—thoroughly addresses all relevant aspects, requirements, and conditions of a specific case or operation. A complete response covers every key point or sub-question posed, ensuring there are no ambiguities or gaps while adhering to any domain-specific rules, constraints, or standards (e.g., technical specifications) necessary for a valid outcome. It provides sufficient detail—clarity, context, and actionable information—so that the intended recipient can proceed without needing further clarification. Moreover, a complete response must be internally consistent, free of contradictions, and devoid of irrelevant information that could confuse. In essence, a response is deemed complete when it fully and accurately meets the objectives or information needs of the particular case or operation, encompassing all essential steps or considerations.

In some examples, the task is to rate the completeness aspect of the generated response with a score. Similarly to the instruction-following 205, a point score may be generated response does not cover the desired content at all. In this case, the completeness would be determined to miss all, if not nearly all, of the material or important aspects of parts of the information that are related to the query. For partially complete responses, a different point score would be attached, and in this case, the generated response covers some of the desired content. However, it does not address or miss significant portions that are deemed pertinent. In other words, the generated response only partially addresses the query and leaves out key details. For another scenario, in which a mostly or nearly complete response is generated, the generated response covers most of the desired content and would likely only miss non-material or minor aspects of relevant information. In this case, the generated response addresses the query satisfactorily but could include more detail for complete completeness. Finally, the last scenario would be a point score for a fully complete response that addresses all material or required aspects of the query. The generated response covers all the desired content and does not miss any important information. It fully addresses the query comprehensively. Again, the scoring system may be configured to be additive in the sense that a response starts at a lower score and can earn additional points as it becomes more complete and covers more of the desired content.

For conciseness 215, similar to the previous evaluations for instruction-following 205 and completeness 210, point scores would be generated for responses that are not concise, in other words, excessively long, and do not capture the essence of the desired content efficiently. In other the generated contains much unnecessary information and could have been more succinct. For example, conciseness may be assessed by comparing the length and detail of a response against the actual information requested. If the system finds repeated statements, unnecessary elaboration, or filler text that does not add value relative to the user’s query, it flags the response as “not concise.” Automated methods may include measuring the ratio of relevant keywords to total word count, detecting repetitive phrases, or applying language models trained to identify superfluous content. In more nuanced setups, human reviewers or specialized “conciseness judges” (LLMs or rule-based systems) evaluate whether the complexity of the question justifies the overall answer length, thus distinguishing between sufficiently detailed answers (e.g., within a threshold range of letters/characters, words, etc.) and those that are excessively long (i.e., equal to or greater than a threshold amount of letters/characters, words, etc.).

Another score, and likely a higher score, would be assigned for a generated response that is primarily concise. In this case, the generated response is of somewhat reasonable length and captures most, if not nearly all, of the desired content efficiently. In this case, the generated response may contain unnecessary information but is generally succinct. Finally, in the last case, the generated response is deemed very or fully concise. The generated response is short in length and captures the essence of the desired content perfectly. It does not contain any unnecessary information and is very succinct. This scoring system is additive in the sense that a response starts at a single point and can earn additional points as it becomes more concise and efficiently captures the essence of the desired content.

For factuality 220, the response to a request is judged in the following contention: In an example, factuality may be evaluated by checking the accuracy of the content against trusted sources or known information. In many systems, this involves cross-referencing specific assertions in the generated text with external knowledge bases, databases, or search APIs to confirm whether the claimed facts align with authoritative data. When automated checks are inconclusive, or a domain is highly specialized, human experts or specialized “factuality judges” (which may themselves be large language models or rule-based engines trained on verified datasets) will review statements to ensure they are correct and flag any discrepancies. Some approaches also employ citation analysis, requiring the model to provide sources for its statements; those sources are then validated for credibility and relevance to determine the factual soundness of the generated response. You are given some context, a query, and a response generated by another AI assistant. Your task is to rate the factuality of the generated response with a score from one to four based on whether the generated response only contains truthful content and does not contain invented or misleading facts that are not supported by the context.

In some examples, the evaluation consists of a single point, or is a single point being added for an entirely factually wrong (“unfactual”) response that is generated in response to a query? For example, the generated response contains no factual information or is entirely misleading. In instances, it may not or does not align with the context at all and invents facts that are not supported by the context.

For a response that is mostly factually wrong but not entirely factually wrong, an additional point score may be added. In this case, the generated response contains some factual information, but a significant portion of the response is either misleading or invented. The response is determined to be partially aligned with the context, but there are apparent discrepancies. In a third case, a third point for a higher score may be awarded for a generated response that is Mostly Factual. For example, the generated response is mainly factual and aligns well with the context. There may be minor discrepancies or slight misinterpretations, but the majority of the response is accurate and does not invent facts.

Finally, a fourth point may be granted for a Completely Factual. In this case, the generated response is entirely factual and aligns perfectly with the context. It does not contain any misleading or invented facts. The response accurately reflects the context without any discrepancies. As mentioned for the other described responses, the configured scoring system is additive in the sense that a response starts at an initial low score and adds additional earned points as it becomes more factual and aligns more closely with the context. The scoring system begins each response at a low baseline score and awards points incrementally as the response grows more factually correct and contextually aligned. This ensures that any discrepancies are identified and penalized and that accurate, context-relevant content is rewarded with a higher final score.

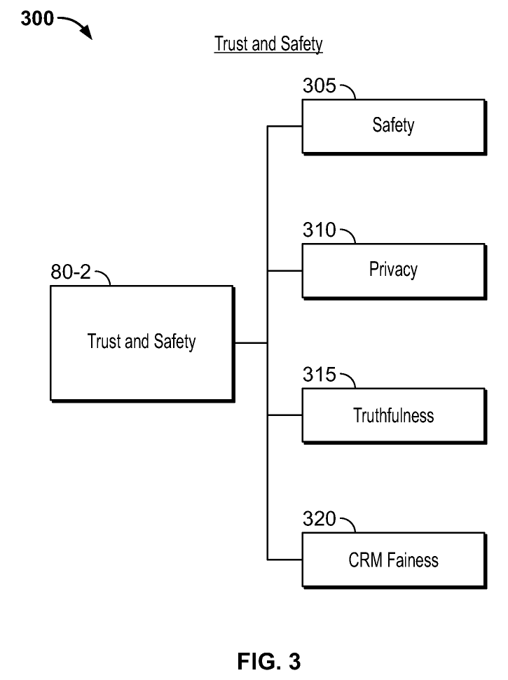

FIG. 3 illustrates an exemplary diagram for aspects of the trust and safety metric calculation of a generated response to a query according to some examples. In FIG. 3, the trust and safety metric 300 is designed to evaluate an LLM's reliability and trustworthiness in managing sensitive customer information, adhering to privacy regulations, securing data, and preventing bias and toxic outputs within CRM use cases. Focusing on these areas provides organizations with a transparent measure of the LLM’s suitability and risk profile for customer relationship management applications. The Key aspects of this metric include safety 305, which is organizational transparency that offers businesses clear visibility into the potential risks and advantages of deploying an LLM in CRM scenarios. The Data Privacy 310 determines a response's level of data privacy compliance. The system evaluates whether the LLM meets or exceeds relevant data protection and privacy standards. The truthfulness 315 of a response is determined by how much veracity can be assigned to the response and whether the response has bias and is configured for toxicity prevention. In this metric, the system assesses the LLM’s ability to avoid producing discriminatory, offensive, or harmful content. These aspects are generally evaluated using a multilayered framework that combines policy-based rules, automated content analysis, and, when necessary, human review. To enforce data protection and privacy compliance, the system implements strict data-handling protocols (e.g., encryption and access controls) during inference and data storage. Policy-checking modules then compare any user-submitted or LLM-generated content against defined regulations or organizational guidelines (e.g., GDPR, HIPAA, proprietary standards), flagging and remediating violations (such as through redaction or rejecting the response). For truthfulness or veracity, the system employs automated fact-checking by cross-referencing the LLM’s statements with trusted knowledge bases and awarding points as alignment with verified information is demonstrated. If the response includes citations, they are automatically tested for relevance, credibility, and accuracy, with additional expert or “judge” modules (LLM-based or human) verifying claims in specialized domains. Bias and toxicity prevention is handled through pre- and post-processing filters that scan for hate speech, discrimination, or other harmful content, as well as fine-tuning and safety layers (e.g., RLHF) designed to mitigate biased or toxic outputs. Continuous monitoring detects patterns of problematic responses, allowing the system to update blocking lists, retrain the model, and adapt guardrails in real-time. Ultimately, all of these checks feed into a composite scoring mechanism, which rewards or penalizes a response based on privacy adherence, factual accuracy, and lack of bias or toxicity—ensuring that only outputs meeting or exceeding relevant standards are deemed acceptable.

Finally, CRM fairness 320 The CRM-centric assessment: Measures the LLM’s effectiveness and compliance in handling highly sensitive customer data within CRM environments.

In some examples, the trust and safety of a response to a query are calculated based on the average (or mean, or another weighted algorithm) of at least four key metrics—Safety, Privacy, Truthfulness, and CRM Fairness expressed as a percentage. For example, specific industries may require higher standards in both trust and safety metrics. In some instances, an algorithm is configured to measure metrics for the safety of a generated response. This may be calculated or measured by how often the LLM refrains from responding to unsafe prompts. In another example, metrics for measuring the privacy of the LLM are determined based on an algorithm configured to measure a metric on how often the LLM refrains from exposing private information. For example, for truthfulness, the algorithm may be configured to evaluate using metrics of the LLM’s accuracy in general knowledge domains.

For CRM fairness, the algorithm may be configured to assess metrics of how unbiased the model’s outputs remain when tested with variations in account and gender information derived from CRM datasets. In some examples, for evaluation metrics, three public datasets are created and accessed and may include, for safety, a “Do Not Answer” dataset being employed. In this instance, the Safety score is computed as 100 minus the percentage of instances where the model refused to respond to unsafe prompts. For privacy, a “Privacy Leakage” dataset is employed. The Privacy score was based on the percentage of cases in both 0-shot and 5-shot scenarios where the model-maintained privacy (e.g., not revealing an email address). For truthfulness, an “Adversarial Factuality” dataset is employed in which the model is measured on how often the model correctly addressed misleading or incorrect facts, expressed as a percentage of correct responses.

In some examples, to measure CRM Fairness, a controlled set of perturbations in the CRM datasets is introduced. For example, the perturbation set may include changing personal names and pronouns (to assess gender bias) or changing company or account names (to assess company/account bias). In an example, gender bias and company/account bias may be determined as the difference in the model’s performance (as measured by accuracy) before and after applying specific perturbations. The CRM Fairness score is the average of these two bias measures.

In some examples, each bias type is tested using five distinct perturbations and applied using a bootstrapping process to understand how random variations in the data affect performance. A threshold value of approximately a result of calculated 95% confidence intervals for CRM Fairness to ensure that any rank beyond the first is statistically significant.

Finally, an aggregated trust and safety measure may be calculated as the average of Safety, Privacy, Truthfulness, and CRM Fairness (as a percentage). In future versions of the CRM benchmark, additional measures may be included to enhance further the robustness and comprehensiveness of the trust and safety metric.

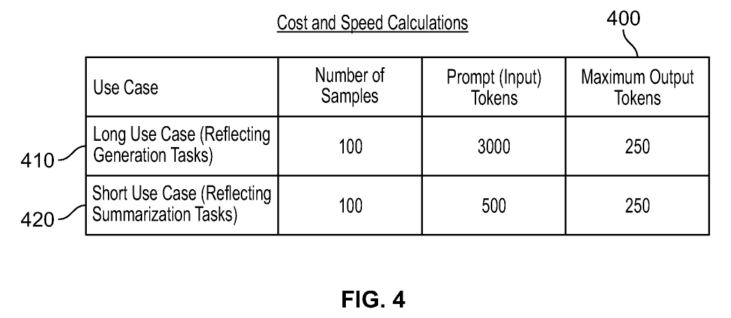

FIG. 4 illustrates an exemplary table of two data sets that are constructed to determine cost and speed calculations according to some examples. In FIG. 4, table 400 shows the first use case, 410, for a prolonged use case that reflects generation tasks, and the second case, 420, shows a short use case reflecting summarization tasks. In some examples, the first and second use cases are based on two prompt datasets that are constructed to evaluate cost and latency. The lengths of prompts in these datasets are approximately 500 tokens and 3000 tokens, reflecting typical prompt lengths for the use cases of generation and summarization, respectively. The prompts are designed to elicit an output of at least 250 tokens, e.g., by prompting the model to cast the input to uppercase. Additionally, a max output token length of 250 is set to ensure a final output length of 250 tokens, reflecting a typical length of outputs across summarization and generation tasks. In some examples, the cost may include a cost metric, which can be or is classified into high, medium, and low categories based on percentiles, representing the estimated operational cost for different CRM use cases to examine LLM performance.

In some examples, the example LLM (Model) latency is used as the proxy of speed. The lower the latency, the faster the model speed is determined to be. The latency measurements are computed based on the mean time to generate the full completion across the above dataset(s). One example of a latency model for a request to LLM is calculated by using code that determines a start time and invokes a response from a particular LLM. The latency is measured based on one typical model latency for which a request is calculated using the following code: mean using calculations based on the model latency of 100 input samples for each use case (Long or Short), respectively. The cost is calculated for one or more externally hosted APIs – hosted directly by the LLM providers or through AWS® Bedrock or other similar applications – costs are computed based on standard per-token pricing.

The cost formula for 1000 requests may be configured as follows: a result computed of an input token price per token multiplied by the number of input tokens, added to the output token price per token multiplied by the number of output tokens multiplied by a fixed determinator (for example, 1000). For in-house models, the cost is estimated using proxy AWS® Bedrock models of size 12B and 52B.

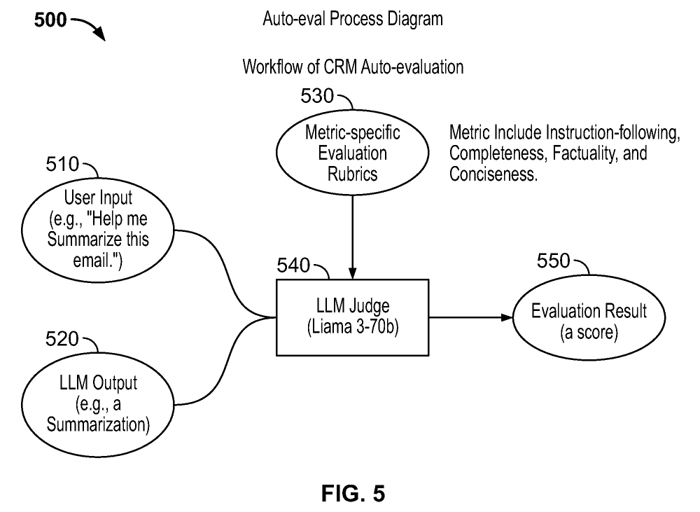

FIG. 5 illustrates an exemplary diagram of an auto-evaluation process of the evaluation system in accordance with some examples. FIG. 5 shows a workflow 500 of the evaluation model that includes the elements of user input 510, LLM output 520, metric-specific evaluation rubrics 530, LLM-judge 540, and evaluation result 550. For each accuracy metric (instruction-following, completeness, etc.), the evaluation system annotates a 4-point scoring rubric as described herein with respect to the Judge Model Prompts. For example, an LLM Judge (a Llama 3-70b model) is configured with (a) the user input, (b) the LLM output to be evaluated, and (c) the metric-specific evaluation rubric in the prompt. The LLM Judge will give a score indicating the quality of the LLM output. For each set of metric scores, the evaluation system calculates an average of the metric scores for all the data points as the final evaluation result.

In some examples, an LLM is used as a "judge" model (LLM-Judge 540) to optimize the evaluation process. This LLM-based method is more scalable, efficient, and cost-effective than manual human evaluation, offering faster turnaround times. Specifically, LLaMA3-70B (LLM-Judge 540) served as the LLM Judge. For each evaluation dimension (e.g., factuality, conciseness), the LLM-Judge 540 received (1) a detailed description of the dimension and a 4-point scoring rubric (metric-specific evaluation rubrics 530) and (2) the input (user input 510) and output (LLM Output 520) from the target model. The LLM-Judge 540 can be instructed to provide its reasoning in a chain of thought and then assign incremental points based on how well the output met the defined criteria. The final score for each dimension was determined by averaging the scores across all data points and generated an evaluation result 550 (a score).

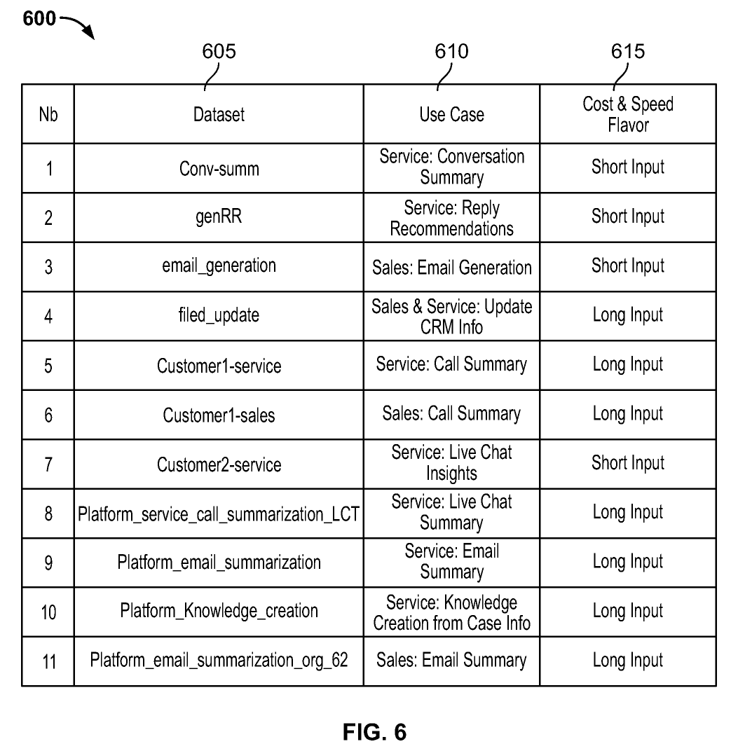

FIG. 6 illustrates an exemplary table 600 of 11 use cases and their corresponding cost and speed according to some examples. Table 600 includes various datasets 605 with associated use cases 610 and the cost and speed flavor 615 for the particular use case. In at least one example, FIG. 6 presents an exemplary Table 600 that lists 11 distinct use cases alongside their corresponding cost and speed attributes. Within Table 600, the column labeled datasets 605 indicates the specific data sources or contexts being evaluated. In contrast, the adjacent use cases 610 column outlines the particular scenarios or applications those datasets address (e.g., summarization, translation, classification). Finally, the cost and speed flavor 615 column provides information about each scenario’s resource expenditure (e.g., compute time, monetary cost) and operational efficiency (e.g., response latency), enabling a straightforward comparison of how different use cases balance expense and performance. This allows stakeholders to identify which use case quickly aligns with desired priorities, whether that means minimizing cost, maximizing speed, or achieving an optimal trade-off between the two.

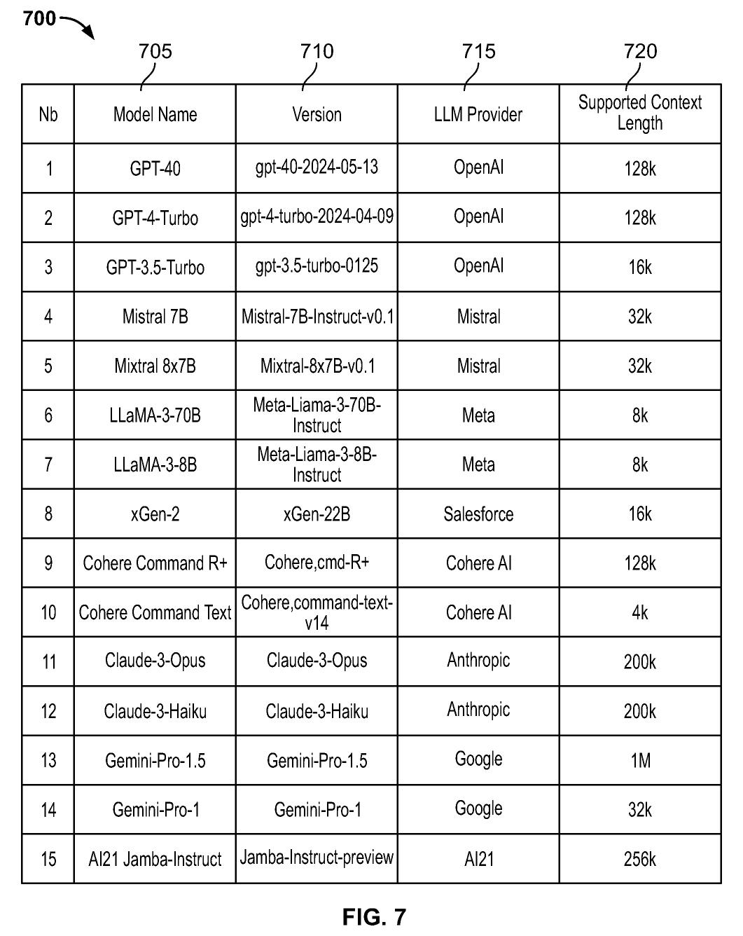

FIG. 7 illustrates an exemplary Table 700 of approximately 15 LLMs for evaluating a set of CRM use cases according to some examples. Table 700 lists the model’s name 705 for the LLM, version 710 of the LLM, the LLM provider 715, and the maximum context length 720 supported by the LLM. In at least one example, FIG. 7 presents Table 700, which features approximately 15 different Large Language Models (LLMs) evaluated for a series of CRM (Customer Relationship Management) use cases. This table includes the model name 705, representing the specific LLM under consideration; version 710, which indicates the release or iteration of each LLM; the LLM provider 715, identifying the organization or entity responsible for developing or hosting the model; and the maximum context length 720, which denotes the upper limit of tokens (or text length) the model can effectively process in a single input. By consolidating these details in one table, stakeholders can quickly compare multiple LLMs in terms of their versioning, provider information, and capacity to handle more extensive or more complex CRM-related queries.

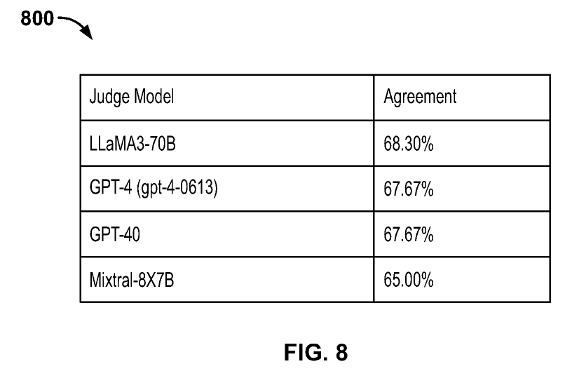

FIG. 8 illustrates an exemplary Table 800 of various judge models to agreements in various datasets according to some examples. In an embodiment, as illustrated in Table 800 of FIG. 8, the evaluation with real people is conducted using both human (manual) and automatic evaluations to assess the accuracy of LLMs for CRM use cases. The dual approach was necessary to ensure the correctness and usability of the auto-evaluation results. To facilitate this process, collaboration was established with application vendor employees and customer employees who handle sales and service functions. The manual evaluation was designed using the same four accuracy metrics on a 4-point scale as the automated evaluation, enabling a more effective comparison between manual and automated results. This also allowed for an assessment of which LLM judge models for auto-evaluation were more aligned with manual results, thus enhancing the auto-evaluation process.

The four-point scale was implemented to ensure that evaluators were compelled to "pick a side" with an even number of options, minimizing the likelihood of neutral scores and ensuring more accurate responses at scale. Additionally, evaluators were given the option to include notes to explain their scoring and provide any relevant observations. To prevent systematic bias, the model names were kept anonymous, and the order of the LLM's responses was randomized for evaluation.

For human agreement, the reliability of the manual evaluation was assessed by measuring pairwise inter-human agreement. Two annotators were considered to agree when both rated output as either "Good" (a score of 3/4) or "Bad" (a score of 1/2) for a specific accuracy dimension (e.g., factuality, conciseness). In three chosen use cases—Service: Reply Recommendations, Sales: Email Generation, and Service: Call Summary—the inter-human agreement was found to be substantial, with an average rate of 78.61%.

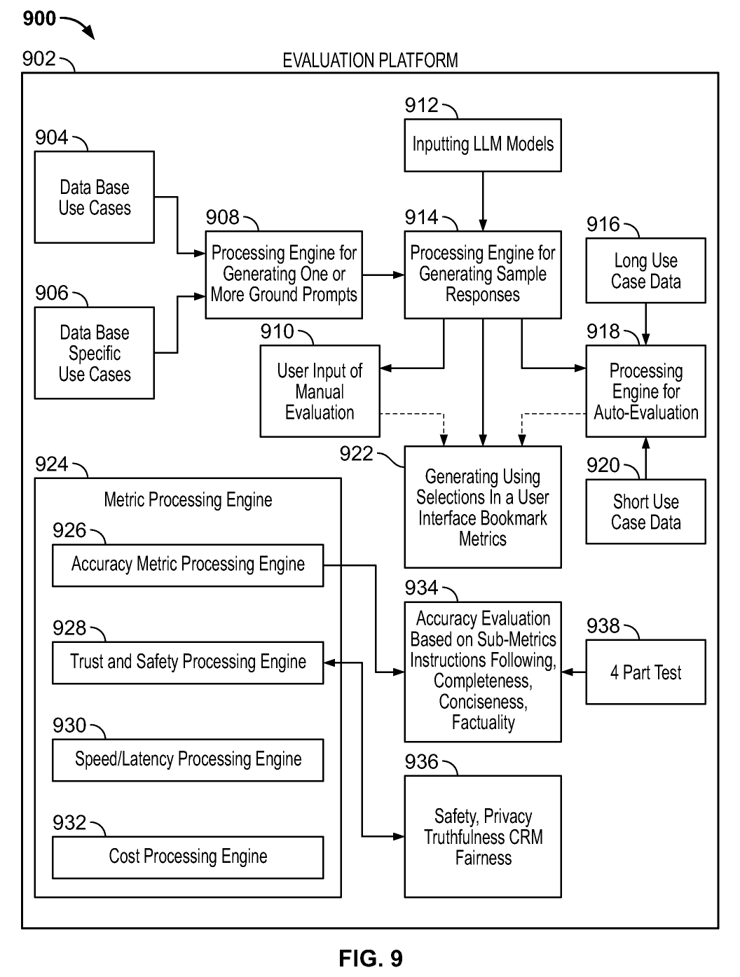

FIG. 9 illustrates an example component configuration 905 of an evaluation platform 900 for performing techniques described herein. In some examples, FIG. 9 is a simplified component architecture diagram of various elements that may be used to enable the evaluation methodologies described herein. The evaluation platform 902 includes one or more databases 904 that contain data sets for various use cases for inputting to a processing engine 908 to generate one or more grounded prompts. In some examples, various databases 906 include specific use cases that may be inputted to the processing engine 908 for the generation of templates as grounded prompts. In some examples, the system manages a sequence of data flows leveraging multiple processing engines to evaluate and refine outputs from one or more Large Language Models (LLMs). First, various databases 906 contain specific use cases, which are fed into processing engine 908 to create grounded prompts (i.e., templates instantiated with relevant data). These prompts, along with stored LLMs accessed from data storage 912, are then provided to the processing engine 914, which generates responses for each use case. At this stage, the system performs two types of evaluation: a manual evaluation (via user input 910) and an automated evaluation by processing engine 918, which can incorporate extended use case data 916 or short use case data 920, depending on the scenario. After processing these data sets with the LLMs, benchmark metrics are configured and presented through a graphical user interface (GUI) 922, enabling users to review and compare the performance and quality of responses in a structured, interactive format. The output of processing engine 908 is sent to processing engine 914 with inputs from data storage 912 containing various LLMs. Also, output from the processing engine 914 is checked based on user input 910 of manual evaluation of the data sets. Also, output from the processing engine 914 is sent for automatic evaluation by the processing engine 918. In some examples, input to the processing engine 918 is received about extended use case data 916 and short use case data 920. After the processing of the data sets using one or more LLMs by the processing engine 914 is completed, one or more benchmark metrics are configured for inputting to a graphical user interface 922.

The graphical user interface, 922, may also receive input from a metric processing engine, 924, that includes generating metric sets for one or more LLMs. The metric sets include accuracy metrics 926, test and cost metrics 928, speed and latency metrics 930, and cost metrics 932. In some examples, the various metrics described are determined using a multi-step evaluation methodology that determinations of various sub-metrics. For example, the accuracy metrics 926 include the evaluation of one or more sub-metrics (benchmark sub-metrics) by the sub-metric evaluation processing engine 934 that evaluates sub-metrics of instruction following, completeness, conciseness, and factuality. In some examples, a 4-point evaluation processing engine 938 is utilized to determine aggregated evaluation scores for each of the sub-metrics. In some examples, trust and safety metric evaluation includes evaluation of the sub-metrics of safety, privacy, truthfulness, and CRM fairness by the trust and safety evaluation processing engine 936. In some examples, the metric processing engine 924 includes inputs from various datasets of use data applicable to one or more LLMs for each of the metrics being evaluated by the metric processing engine 924 corresponding to the accuracy, trust and safety, speed and latency, and cost metric as described herein.

In some examples, the various processing engines described for generating sample responses, processing ground prompts, auto-evaluation of data sets, processing metric data, generating benchmarks, and creating selective GUIs with one or more LLMs for selection based on particular use cases may use techniques and solutions that apply AI technologies for classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware or software-based framework for training, processing, fine-tuning, or performing any other implementation steps. Furthermore, AI technology may include a hardware software-based framework that performs one or more functions, such as retrieving, generating, accessing, transmitting, etc. The AI technology may be implemented by a computer, including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to train the AI technology further. The AI technology may offer a variety of capabilities, including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train the output of the various processing engines, a plurality of input prompts may be provided to the processing engines for the purpose of eliciting particular responses. In various implementations, the plurality of input prompts may correspond to the particular field or task to which the processing engine is trained. Additionally, the various processing engines may include AI technology that may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

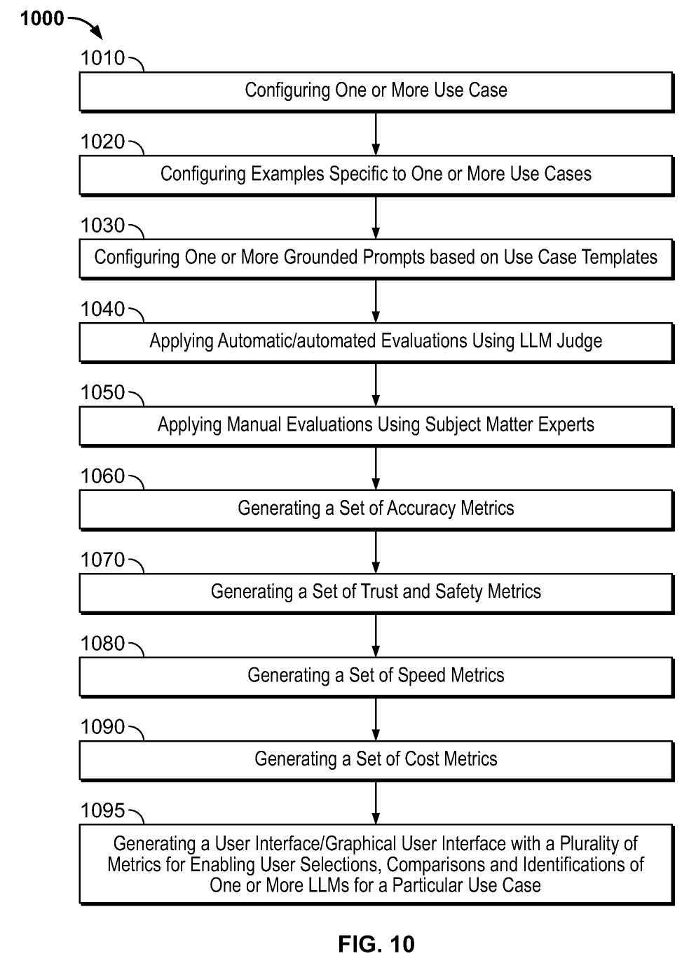

FIG. 10 is a flow diagram illustrating an example process 1000 for evaluating one or more models for use cases according to examples. The processes illustrated in FIG. 10 are described with reference to components described above with reference to the example evaluation environment, systems, and platform shown in FIGS. 1-9. for convenience and ease of understanding. However, the processes illustrated in FIG. 10 are not limited to being performed using the components described above with reference to the example evaluation environment, systems, and platform shown in FIGS. 1-9. Moreover, the components described above with reference to the example environment, systems, and platform are not limited to performing the processes illustrated in FIG. 10.

Process 1000 is illustrated as a collection of blocks of modules in a logical flow diagram, representing sequences of operations, some or all of which can be implemented in hardware, software, or a combination thereof. In the context of software, the blocks or modules represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks or modules can be combined in any order and/or in parallel to implement the processes or alternative processes. Not all of the blocks or modules need to be executed in all examples. For discussion purposes, the processes herein are described in reference to the frameworks, architectures, and environments described in the examples herein. However, the processes may be implemented in a wide variety of other frameworks, architectures, or environments.

In some examples, the processes described for evaluating LLMs and for selecting an appropriate LLM may include applying Retrieval Augmented Generation (RAG) to automatically embed the most current and relevant proprietary data directly into their LLM prompt; this may include retrieving all or nearly all available data, including unstructured data: emails, PDFs, chat logs, social media posts, and other types of information that can lead to a better AI output.

In some examples, the processes described generate one or more benchmarks that can be considered a living tool that is continually updated with more use cases across more clouds, more manual evaluations, and more LLMs, including fine-tuned LLMs and small LLMs (under 4 billion parameters); and context windows, which define how much information a model can take on.

In some examples, the processes described apply a CRM benchmark framework that is configured to identify an enhanced solution for the particular needs of an organization and make informed decisions, balancing accuracy, cost, speed, trust, and safety. As an example, the SALESFORCE® Einstein platform can provide users a process to choose from existing LLMs or enable unique users to be generated to meet particular business requirements. By selecting models for their CRM use cases using the benchmark, businesses can deploy more effective and efficient regenerative AI solutions.

At operation 1010, process 1000 can include configuring one or more use case data for inputting to various processing engines. In one example, data sets of use cases may be inputted to a processing engine to generate one or more grounded prompts. In some examples, multiple use cases are configured for evaluating one or more LLMs by evaluation systems and methods for a set of selected and/or available LLMs. In instances, each use case is configured or based on aggregated use case data applied or used by one or more LLM models that are subsequently displayed in a listing for visual comparison of certain attributes. In one example, a process may be provided for application by the LLM evaluation system and methods using an LLM judge (i.e., using a module configured for LLM judge operations) for evaluating a plurality of LLM models for a plurality of use cases. For example, by assessing a plurality of quantities such as accuracy, cost, speed, trust, and safety with selected criteria for each LLM model by comparisons of each LLM model with aggregated use data and the selected criteria using a scoring tool. The evaluation of each LLM model may be automatically performed using different language models.

At operation 1020, process 1000 includes configuring one or more examples of use cases. In some examples, multiple use cases are configured for evaluating one or more LLMs by evaluation systems and methods for a set of selected and/or available LLMs. In instances, each use case is configured or based on aggregated use case data applied or used by one or more LLM models that are subsequently displayed in a listing for visual comparison of specific attributes.

At operation 1030, process 1000 includes configuring one or more examples for grounded prompts based on use case templates. For example, one or more ground prompts that may include use case templates instantiated with one or more specific examples.

At operation 1040, process 1000 includes applying automated evaluations (auto-evaluations) using one or more LLM judges. For example, using an LLM judge (i.e., using a processing engine configured for LLM judge operations) for evaluating a plurality of LLM models for a plurality of use cases. For example, by assessing a plurality of quantities such as accuracy, cost, speed, trust, and safety with selected criteria for each LLM model by comparisons of each LLM model with aggregated use data and the selected criteria using a scoring tool. The evaluation of each LLM model may be automatically performed using different language models.

At operation 1050, process 1000 includes applying a manual evaluation of data sets for use cases. For example, the manual evaluation may rely on subject matter experts to conduct manual evaluations of outputs for processing by the LLMs. In some instances, multiple entities may be involved in the manual evaluation process to enhance the reliability of the data inputted into each language model. For instance, if there is a disagreement in an evaluation between more than one evaluator, the data may be discarded as its reliability may prove to be deficient. Hence, both an automated and a semi-automated approach is formulated to enhance the reliability of the data inputted into each language model without impinging or causing bottlenecks in the processing of the data being inputted to each LLM. In some examples, a multi-prong or a 2-prong approach for evaluating and assessing the performance of various generative AI models across different domains may be configured. For instance, the first prong of the approach may use a strictly automated evaluation process. The automated evaluation process may have limitations, constraints, and/or deficiencies when applied to determinations that cannot be easily quantified. To address such challenges, a second prong of the approach may be integrated that includes a manual step. That is, the manual process may be incorporated or integrated with the automated evaluation process when necessary, which may cause an increase in the accuracy of automated evaluation processes.

At operation 1060, process 1000 includes generating accuracy metrics for each LLM model based on use cases. In some examples, generating a metric of accuracy (often considered a primary metric for evaluating an LLM) may include or encompass four key aspects that include the sub-metrics of factuality, completeness, conciseness, and instruction-following. Accurate predictions and recommendations may result by effectively making determinations of the various sub-metrics described. They may also provide valuable insights for one or more users across a network or an organization, enabling better decision-making to enhance the customer experience. While achieving a high level of accuracy is important, it may be deemed that it is equally critical to evaluate other metrics. For use cases where accuracy falls short, strategies like prompt engineering and fine-tuning can be employed to improve outcomes.

At operation 1070, process 1000 may include generating trust and safety metrics. This metric may determine or assess an LLM's ability to safeguard sensitive customer data, comply with data privacy regulations, maintain information security, and avoid bias or toxicity in CRM applications.

At operation 1080, process 1000 may include generating speed and latency metrics. In some examples, a user may weigh one or metrics differently to make value determinations of one or more LLMs. For example, a metric of speed or latency may be used to evaluate an LLM's responsiveness and efficiency in processing and delivering information. The rationale may be that a faster response time of an LLM may materially enhance the user experience, minimize customer wait times, empower sales and service teams to address inquiries, and resolve issues more efficiently.

At operation 1090, process 1000 may include generating cost metrics. In some examples, organization may weigh one or metrics differently to make value determinations of one or more LLMs. For example, a metric of speed or latency may be used to evaluate an LLM's responsiveness and efficiency in processing and delivering information. The organization's rationale may be that a faster response time of an LLM may materially enhance the user experience, minimize customer wait times, empower sales and service teams to address inquiries, and resolve issues more efficiently.

At operation 1095, process 1000 may generate a plurality of evaluation metrics for visual display in a graphical user interface (GUI) for selection, to receive at least one evaluation metric selected from the plurality of evaluation metrics, and to apply a scoring tool based on at least one evaluation metric. Further, the process may be identified by using an algorithm to allow the determination of one or more LLMs from a list of LLM modules that meet criteria based on aggregated use case data applied to each LLM compared to the selected evaluation metric; prioritize, by the algorithm, one or more LLM models which have been determined based on the aggregate use case data and the chosen evaluation metric; and display in a graphical interface one or more LLM models in accordance with a priority and output from the scoring tool for visual identification of an LLM for use in a particular use case. The plurality of evaluation metrics comprises at least one metric associated with cost, speed, trust. or safety, and the evaluating step comprises both an automatic and a manual evaluation process.

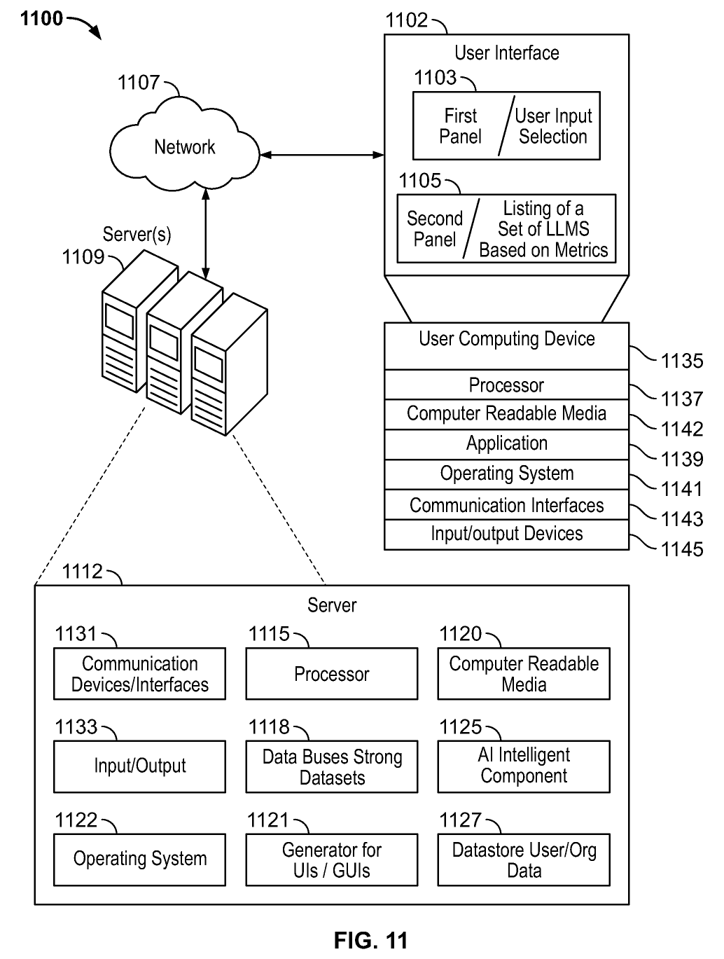

FIG. 11 illustrates an example system for performing techniques described herein. In some examples, FIG. 11 is a simplified diagram of a computing device implementing an LLM assessed based on specific criteria via an evaluation network, according to some examples. In at least one example, the example evaluation network environment (“example environment”) 1100 includes a configurable graphical user interface (or user interface) 1102 that may act as a platform for configuring models to various selectable features and accessible or communicable via a network 1107 that may be connected to one or more server computing devices (or “server(s)”) 1109. In at least one example, the server(s) 1109 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth. However, other computer architectures can additionally or alternatively be used.

In at least one example, the server(s) 1109 can communicate with a user computing device 1135 via one or more network(s) 1107. That is, the server(s) 1109 and the user computing device 1135 can transmit, receive, and/or store data 1127 (e.g., content, information, or the like) using the network(s) 1107, as described herein. The user computing device 1135 can be any suitable type of computing device, e.g., portable, semi-portable, semi-stationary, or stationary. Some examples of the user computing device 1135 can include a tablet computing device, a smartphone, a mobile communication device, a laptop, a netbook, a desktop computing device, a terminal computing device, a wearable computing device, an augmented reality device, an Internet of Things (IoT) device, or any other computing device capable of sending communications and performing the functions such as generating graphic user interfaces for enabling evaluating of LLMs according to the techniques described herein. While a single user computing device 1135 is shown, in practice, the example environment 1100 can include multiple (e.g., tens of, hundreds of, thousands of, millions of) user computing devices. In at least one example, user computing devices, such as the user computing device 1135, can be operable by users to, among other things, access communication services via the communication platform (communication interfaces 1131). A user can be an individual, a group of individuals, an employer, an enterprise, an organization, and/or the like.

The network(s) 1107 can include, but are not limited to, any network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 1107 are well known and are not discussed herein in detail.

In at least one example, the server(s) 1112 can include one or more processors 1115, computer-readable media 1120, one or more communication interfaces 1131, and/or input/output devices 1133. Other components may also be added and include various databases 1118 capable of storing one or more datasets for a number of different use cases and providing the use data to various LLMs for algorithmic analysis and comparisons of the outputs based on criteria selected in a graphical user interface 1102 by a user. Also, at server 1112, artificial intelligent components may be enabled or configured to provide different LLMs for comparison operations. For example, the SALESFORCE® EINSTEIN artificial intelligence application may be accessed. It may be configured to provide different LLMs for listing and identifying in accordance with one or more selected metrics in the graphic user interface 1102.

In at least one example, each processor of the processor(s) 1115 can be a single processing unit or multiple processing units and can include single or multiple computing units or multiple processing cores. The processor(s) 1115 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 1115 can be one or more hardware processors and/or logic circuits of any suitable type specifically programmed or configured to execute the algorithms and processes described herein. The processor(s) 1115 can be configured to fetch and execute computer-readable instructions stored in the computer-readable media, which can program the processor(s) to perform the functions described herein.

The computer-readable media 1120 can include volatile and nonvolatile memory and/or removable and non-removable media implemented in any type of technology for storage of data, such as computer-readable instructions, data structures, program modules, or other data. Such computer-readable media 1120 can include, but is not limited to, RAM, ROM, EEPROM, flash memory or other memory technology, optical storage, solid-state storage, magnetic tape, magnetic disk storage, RAID storage systems, storage arrays, network attached storage, storage area networks, cloud storage, or any other medium that can be used to store the desired data, and a computing device can access that. Depending on the configuration of the server(s) 1112, the computer-readable media 1120 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1120 can be used to store any number of functional components that are executable by the processor(s) 1115. In many implementations, these functional components comprise instructions or programs that are executable by the processor(s) 1115 and that, when executed, specifically configure the processor(s) 1115 to perform the actions attributed above to the server(s) 1112. Functional components stored in the computer-readable media can optionally include AI component 1125 and a datastore 1127.

In at least one example, the operating system 1122 can manage the processor(s) 1115, computer-readable media 1120, hardware, software, etc. of the server(s) 1112.

In at least one example, the datastore 1127 can be configured to store data that is accessible, manageable, and updatable. In some examples, the datastore 1127 can be integrated with the server(s) 1112, as shown in FIG. 11. In other examples, the datastore 1127 can be located remotely from the server(s) 1109 and can be accessible to the server(s) 1112 and/or user device(s), such as the user device 1135. The datastore 1127 can comprise multiple databases, which can include user/org data. Additional or alternative data may be stored in the data store and/or one or more other data stores.

The communication interface(s) 1131 can include one or more interfaces and hardware components for enabling communication with various other devices (e.g., the user computing device 1135), such as over the network(s) 1107 or directly. In some examples, the communication interface(s) 1131 can facilitate communication via WebSockets, Application Programming Interfaces (APIs) (e.g., using API calls), Hypertext Transfer Protocols (HTTPs), etc.

The server(s) 1112 can further be equipped with various input/output devices 1133 (e.g., I/O devices). Such I/O devices 1133 can include a display, various user interface controls (e.g., buttons, joystick, keyboard, mouse, touch screen, etc.), audio speakers, connection ports, and so forth.

In at least one example, the user computing device 1135 can include one or more processors 1137, computer-readable media 1142 or applications 1139, one or more communication interfaces 1143, input/output devices 1145, and operating system 1141.

In at least one example, each processor of the processor(s) 1137 can be a single processing unit or multiple processing units and can include single or multiple computing units or multiple processing cores. The processor(s) 1137 can comprise any of the types of processors described above with reference to the processor(s) 1137 and may be the same as or different than the processor(s) 1137.

The computer-readable media 1142 or application 1139 can comprise any of the types of computer-readable media 1142 described above with reference to the computer-readable media 1142 and may be the same as or different than the computer-readable media or application 1139. Functional components stored in the computer-readable media can optionally include at least one application and an operating system 1141.

In at least one example, application 1139 can be a mobile application, a web application, or a desktop application, which can be provided by the communication platform or which can be an otherwise dedicated application. In some examples, individual user computing devices associated with the environment 1100 can have an instance or versioned instance of the application 1139, which can be downloaded from an application store, accessible via the Internet, or otherwise executable by the processor(s) 1137 to perform operations as described herein. That is, the application 1139 can be an access point, enabling the user computing device 1135 to interact with the server(s) 1112 to access and/or use communication services available via the communication platform. In at least one example, the application 1139 can facilitate the exchange of data between and among various other user computing devices, for example via the server(s) 1112. In at least one example, application 1139 can present user interfaces as described herein. In at least one example, a user can interact with the user interfaces via touch input, keyboard input, mouse input, spoken input, or any other type of input.

In at least one example, the operating system 1141 can manage the processor(s) 1137, computer-readable media 1142, hardware, software, etc. of the server(s) 1112.

The communication interface(s) 1143 can include one or more interfaces and hardware components for enabling communication with various other devices (e.g., the user computing device 1135), such as over the network(s) 1107 or directly. In some examples, the communication interface(s) 1143 can facilitate communication via WebSockets, APIs (e.g., using API calls), HTTPs, etc.

The user computing device 1135 can further be equipped with various input/output devices 1145 (e.g., I/O devices). Such I/O devices 1145 can include a display, various user interface controls (e.g., buttons, joystick, keyboard, mouse, touch screen, etc.), audio speakers, connection ports, and so forth.

The graphical user interface (GUI) 1121 can be configured using a graphical user interface generator 1121 of the server 1112. The GUI may display one or more benchmarks that are presented by the LLM evaluation platform via an interactive dashboard or leaderboard. For example, the interactive dashboard may be configured as a TABLEAU® dashboard and/or using a collaborative platform for displaying the leaderboard, such as HUGGING FACE®. In some examples, by user selection in a first panel 1103, different modeling of one or more attributes associated with each LLM may be performed to produce different modeled results. For example, LLMs may be filtered and presented in a second panel 1105 in a list with side-by-side views of criteria to be weighed and selected based on one or more selectable items. In an instance, to make a selection for an LLM by a user interested in improving a sales department, the user may first establish threshold criteria and then proceed in making tradeoffs to revise the initial listing of LLMs based on various metrics such as accuracy, cost, and trust and safety.

For example, the user may initially weigh accuracy more and then determine that a particular set of models is deemed sufficiently accurate. Then, drilling down on the list based on one or more of the other metrics results in a further reordering of the list for a different weighting of the list of LLM, enabling a different and/or enhanced contextual visual depiction and subsequent understanding of the user of a more appropriate or more suitable LLM for the particular use case. The number of models presented in the graphical user interface (GUI) 1121 for user selection can be increased or decreased based on the likelihood of use and selection for each use case. Each of the models for a particular use case has been tested with use case data that is dynamically uploaded and inputted to each model to enable model evaluations and applicability. Hence, each model has already been provisioned with appropriate use case data, and computed values for each model in the various metrics have already been processed.

While techniques described herein are described as being performed by the systems, described herein can be performed by any other component or combination of components, which can be associated with the server(s) 1112, the user computing device 1135, or a combination thereof.

### User Interface for an LLM Evaluation System

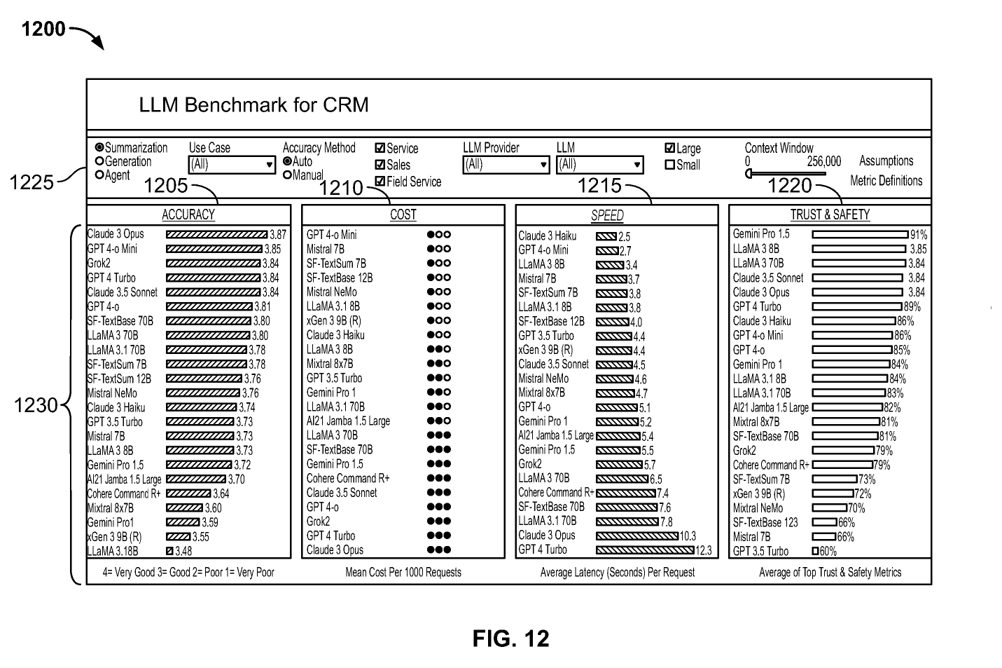

FIG. 12 illustrates a graphical user interface 1200 configured for filtering the type of use case and selecting various metrics for ranking suitable LLMs according to some examples. FIG. 12 illustrates an exemplary dashboard for configuring one or more benchmarks to determine a suitable LLM for a particular use case. The user interface 1200 comprises a plurality of objects such as panes, entry fields, buttons, messages, or other user interface components that are viewable by a user using a mobile device connectable to a network. As depicted, the user interface 1200 comprises a title bar “LLM BENCHMARK FOR CRM,” an upper panel 1225, and a lower panel 1230, which allows for defining a use case environment to identify a suitable LLM from a set of LLMs that are displayed in a listing of the lower panel 1230.

In a selection process of the user interface 1200, in the upper panel, a user may choose one of a number of objects of the Summarization, Generation, or Agent option in the top left corner of the dashboard of the upper panel. Summarization is the easiest place to start. In the Accuracy column 1205, you will be given notice of the models scoring at least a three (which equals good). The accuracy breakdown lets the user drill down to see metrics on instruction following, completeness, conciseness, and factuality. Next, a user may choose a use case from a drop-down menu configured in the upper panel 1225, like Service: Call Summary. For example, the user may look for models that score at least a three for accuracy. If a score is less than three, look for another option or double-check the Accuracy Breakdown. In instances, the user can switch between Auto and Manual modes for the Accuracy Method; the manual is more reliable. For example, from the list of accurate models, review costs 1210 to ensure achieving good ROI. For example, some use cases require a quick response, so in this instance, a user may look for a model that suits a need for speed 1215. A user may also evaluate the trust and safety 1220 for particular use cases. Specific industries may be more sensitive here. The user may also consider LLMs that are on the vendor Virtual Private Cloud for even greater security.

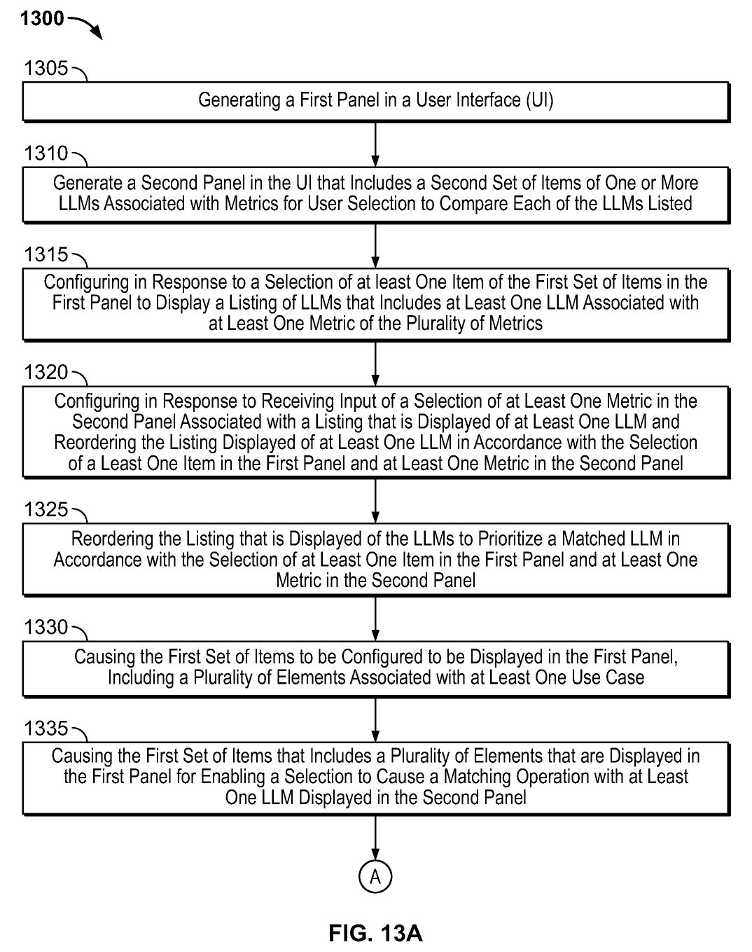

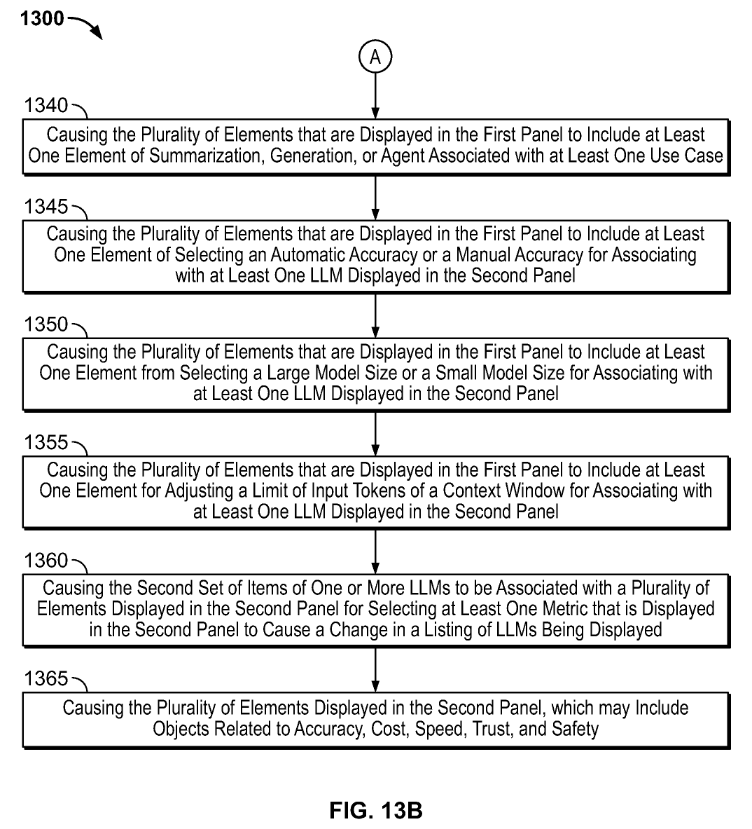

FIGS. 13A and 13B are flow diagrams illustrating an example process 1300 for evaluating one or more models for use cases according to examples—the processes illustrated in FIG. 13A/13B are described with reference to components described above with reference to the example evaluation environment, systems and platform shown in FIGURES for convenience and ease of understanding—however, the processes illustrated in FIG. 13A/13B is not limited to being performed using the components described above with reference to the example evaluation environment, systems, and platform shown in FIGURES. At 1305, process 1300 is configured for generating a first panel in a user interface UI. The UI in the first panel may present or display a first set of items where each item is identified with at least one use case that is applicable for at least one LLM. At 1310, the process may be configured to generate a second panel in the GUI. The second panel, the lower panel, may include a second set of items of one or more LLMs associated with metrics for user selection to compare each of the LLMs listed based on particular attributes. In instances, the LLM listed may be mapped to at least one item of the first set of items.

At 1315, process 1300 is configured in response to a selection of at least one item of the first set of items in the first panel to display a listing of LLMs that includes at least one LLM associated with at least one metric of the plurality of metrics. At 1320, process 1300 is configured in response to receiving input of a selection of at least one metric in the second panel associated with a listing that is displayed of at least one LLM, reordering the listing that is displayed of at least one LLM in accordance with the selection of at least one item in the first panel and the selection of at least one metric in the second panel.

At 1325, process 1300 is configured to enable reordering the listing that is displayed of the LLMs and to prioritize a matched LLM in accordance with the selection of at least one item in the first panel and at least one metric that is selected in the second panel. At operation 1325 in process 1300, the system is configured to reorder the displayed listing of Large Language Models (LLMs) and prioritize a matched LLM based on user selections made in two panels: (1) at least one item in the first panel, and (2) at least one metric in the second panel. For example, the first panel may list different use cases, domains, or functional requirements. In contrast, the second panel may list evaluation metrics such as accuracy, speed, cost, or trust and safety. When the user selects an item from the first panel (e.g., a specific customer relationship management use case) and one or more relevant metrics from the second panel (e.g., prioritizing speed over cost), the system recalculates the ranking of the LLMs accordingly. This ranking update may rely on metadata, historical test results, or real-time performance data tied to each LLM. By adjusting the display order, the interface highlights the best-matched LLM at the top of the list or otherwise visually indicates that an LLM is most suitable for the selected criteria. This dynamic reordering provides immediate feedback to users, allowing them to quickly identify and evaluate the LLM that best meets their chosen use case and performance priorities.

At 1330, process 1300 causes the first set of items to be configured to be displayed in the first panel, including a plurality of elements associated with at least one use case. At 1330 in process 1300, the system configures a first set of items to be displayed in the first panel, where these items encompass a plurality of elements associated with at least one use case. This means the interface populates the panel with relevant data—such as use case categories, subtasks, or feature sets—that provide a structured overview of the scenario(s) in question. In some examples, these elements might be drawn from stored metadata (e.g., domain information, functional requirements, or performance objectives). They can be dynamically updated based on the user’s previous selections or other contexts. By presenting these items in the first panel, process 1300 ensures that users have a clear, interactive view of the various use case components or domains, enabling them to easily navigate and select the elements that are most pertinent to their assessment or project goals.

At 1335, process 1300 causes the first set of items that includes a plurality of elements that are displayed in the first panel for enabling a selection to cause a matching operation with at least one LLM displayed in the second panel. At 1335 in process 1300, the system displays a first set of items in the first panel, each representing one or more elements (e.g., domain requirements, functional parameters, or performance goals) that users may select. Once a user chooses one or more of these elements, the system performs a matching operation against at least one Large Language Model (LLM) displayed in a second panel. This matching operation may involve comparing metadata and characteristics (such as model size, training data, known performance metrics, or cost attributes) against the elements the user selected, resulting in a filtered or re-ranked view of LLMs in the second panel. In doing so, process 1300 helps users quickly identify which LLMs best align with the chosen criteria, streamlining the selection process for optimal model performance or suitability for the specified use case.

At 1340, process 1300 causes the plurality of elements that are displayed in the first panel to include at least one element of summarization, generation, or agent associated with at least one use case to enable a matching operation with at least one LLM displayed in the second panel. At operation 1340 in process 1300, the system ensures that the plurality of elements displayed in the first panel explicitly includes at least one element associated with summarization, generation, or agent functionality (or any combination thereof) tied to a particular use case. When a user selects one of these elements, the system triggers a matching operation against at least one Large Language Model (LLM) shown in the second panel. This mechanism allows the user to narrow down or filter the list of available LLMs based on the specific capabilities—such as summarizing complex text, generating new content, or acting as an interactive agent—needed for the chosen use case. As a result, process 1300 helps streamline the discovery and selection of an appropriate LLM by linking the user’s desired task (e.g., summarization, generation, or agent) with an LLM suited to fulfilling that requirement.

At 1345, process 1300 causes the plurality of elements that are displayed in the first panel to include at least one element of selecting an automatic accuracy or a manual accuracy for associating with at least one LLM displayed in the second panel. At 1345 in process 1300, the system is configured so that the plurality of elements displayed in the first panel includes at least one accuracy selection element, which offers a choice between automatic accuracy or manual accuracy options. When a user selects one of these accuracy types, the system associates that choice with at least one Large Language Model (LLM) displayed in the second panel. This association may involve applying either an automated scoring mechanism (e.g., algorithmic or LLM-based evaluator) or a human-in-the-loop review process (e.g., subject matter experts, end users) to assess the LLM’s performance. By allowing users to opt for either automatic or manual accuracy, process 1300 ensures greater flexibility in how an LLM’s results are judged—enabling quick, automated checks when speed is a priority, or more nuanced, human-based evaluations when precision or contextual insight is paramount.

At 1350, process 1300 causes the plurality of elements that are displayed in the first panel to include at least one element of selecting a large model size or a small model size for associating with at least one LLM displayed in the second panel. At 1350 in process 1300, the system adds an element to the first panel that enables users to specify whether they prefer a large model size or a small model size for at least one Large Language Model (LLM) displayed in the second panel. By selecting “large model size,” a user may be opting for an LLM with more parameters, typically offering higher accuracy or more complex capabilities at the cost of greater compute resources and potentially higher latency. Conversely, choosing a “small model size” may prioritize lower resource usage, faster inference, or reduced costs, though possibly at the expense of some performance metrics (e.g., nuanced reasoning or advanced language features). Once the user makes a selection, the system filters or reorders the LLMs in the second panel, accordingly highlighting or prioritizing those best matching the chosen size requirement. This dynamic configuration helps stakeholders quickly identify which model size aligns with their specific operational constraints, performance goals, or budgetary considerations.

At 1355, process 1300 causes the plurality of elements that are displayed in the first panel to include at least one element for adjusting a limit of input tokens of a context window for associating with at least one LLM displayed in the second panel. At 1355 in process 1300, the system displays an element in the first panel that allows users to adjust the limit of input tokens (i.e., context window size) associated with at least one Large Language Model (LLM) shown in the second panel. When this element is selected, the user can set a maximum number of tokens for the model’s input, balancing factors such as performance, cost, and accuracy. A higher token limit can enable more extensive context for complex queries but may increase computational overhead and latency. Conversely, a lower token limit can reduce resource usage and potentially speed up processing, though it might also constrain the model’s ability to handle lengthy or detailed prompts. By providing this adjustable token limit, process 1300 allows stakeholders to fine-tune an LLM’s context window in alignment with specific task requirements, usage constraints, or resource considerations.

At 1360, process 1300 causes the second set of items of one or more LLMs to be associated with a plurality of elements displayed in the second panel for selecting at least one metric of a plurality of metrics that are displayed in the second panel to cause a change in a listing being displayed of at least one LLM in the second panel. At 1360 of process 1300, the system associates a second set of items—representing one or more Large Language Models (LLMs)—with a plurality of elements displayed in the second panel. These elements can include metrics such as accuracy, latency, cost, and trust and safety. When a user selects at least one of these metrics, the system recomputes, reorders, or refines the list of LLMs shown in the second panel to highlight those that best align with the chosen metric(s). For instance, if the user selects a metric emphasizing low latency, the system may elevate or filter LLMs that are known to provide faster responses. Conversely, a selection favoring cost-effectiveness could reorder the list to prioritize models with lower computational expenses. By making these dynamic updates in real-time, the system allows users to quickly evaluate and compare multiple LLMs based on the metrics most pertinent to their goals, ensuring that each LLM’s ranking in the second panel reflects the latest user preferences and business requirements.

At 1365, process 1300 causes the plurality of elements displayed in the second panel, which may include objects related to accuracy, cost, speed, trust, and safety. At 1365 in process 1300, the system displays a plurality of elements in the second panel, which may encompass objects or metrics pertinent to accuracy, cost, speed, trust, and safety. These elements serve as the evaluative dimensions through which one or more Large Language Models (LLMs) can be measured or compared. For instance, accuracy might reflect how closely a model’s outputs align with ground-truth data, while cost could track resource usage or financial expenditure. Speed may highlight the responsiveness or latency of model inferences, whereas trust and safety measure compliance with guidelines or content policies. By providing these elements in the second panel, process 1300 ensures that users can select, prioritize, or filter LLMs based on the key performance indicators that are most relevant to their specific goals or constraints.

In an example case for evaluation of LLM of an evaluation of general instruction-tuned Large Language Models (LLMs) that are specifically GPT-4 and GPT-4-Turbo. In this case, the object was to assess models in a variety of tasks without relying on task-specific fine-tuning. The methodology for this case evaluation included using GPT-4: Conversation summaries, email generation for sales, CRM information updates, and reply to recommendations for service; and GPT-4-Turbo: Live chat insights, email summaries, call summaries, knowledge creation from case information, and additional live chat and call summaries. The Latency and Hosting were measured latency under two scenarios to mimic common use cases: (1) ~500 tokens in and ~250 tokens out; (2) ~3000 tokens in and ~250 tokens out. The reported scores reflected the average time to receive a complete response over a high-speed internet connection. External APIs were hosted either directly by providers (OPENAI®, GOOGLE®, AI21) or offered through AMAZON® Bedrock (COHERE®, ANTHROPIC®). Self-hosted models utilized the DJL serving framework with vLLM engine on G5.48xlarge instances for 7B models and P4d.24xlarge instances for the 70B model. In this case, the Evaluation and Cost Considerations were as follows: LLM annotations (manual/human evaluations) were carried out on a selected subset of models, with no strict control over ordering effects. Costs for external APIs were based on the provider’s standard pricing. COHERE® and ANTHROPIC® through AMAZON® Bedrock followed the same rate as their direct APIs. For self-hosted models, we assumed a minimal frequency of calls, as compute costs are incurred on an hourly basis. The evaluation for Trust and Safety, such as for Bias Benchmarks, was modeled as follows: the trust and safety evaluation involved both public datasets and CRM datasets with bias perturbations (e.g., varying names, pronouns, and company details to detect bias). In some examples, a higher CRM Fairness score indicates lower bias. For the auto-evaluation with LLaMA-70B, in this case, LLaMA-70B was employed as an automatic judge due to its strong correlation with human annotators. However, it may be acknowledged that LLM-based judging remains an evolving area of research. The JSON output required reformatting. In some instances, some manual evaluations required valid JSON outputs from the models. When necessary, it was needed to have reformatted valid JSON into plain text to enhance readability. In cases where the model produced invalid JSON that could be parsed using minor adjustments, the resulting JSON was also reformatted and flagged with a note.

Below are examples of use cases that illustrate how organizations can leverage the described system demonstrating how an organization might leverage the described system of processors, non-transitory computer-readable media, and benchmarking processes to receive datasets, generate grounded prompts, benchmark multiple LLMs, and display a dynamically ordered GUI for selecting the most suitable model.

### Use Case 1: Enterprise Knowledge Management

### Scenario:

A large enterprise wants to create a knowledge management solution for its internal documentation. The goal is to allow employees to ask questions in natural language and retrieve concise, accurate responses from a corpus of company policies, technical manuals, and FAQs.

### System Flow

Data Set Input: The system receives a set of text documents related to HR policies, product specifications, and departmental FAQs as the “data set” for the use case.

Grounded Prompt Generation: The system creates grounded prompts that embed these documents or summaries of them, ensuring each query to the LLM is contextually relevant.

LLM Identification: Based on the “knowledge management” use case tag and the system’s internal algorithm, a set of LLMs with strong retrieval and summarization capabilities is identified.

Benchmark Configuration: The system configures benchmarks focusing on accuracy, speed, and trust and safety—e.g., ensuring the model does not divulge confidential information. The system evaluates how each LLM of the set of LLMs would process such information in terms of accuracy, speed, and trust and safety.

GUI Display & Ordering: The user interface lists the LLMs and allows administrators to prioritize or filter models based on metrics like speed (for real-time Q&A) or trust and safety (to protect sensitive data).

### Use Case 2: Customer Support Chatbot

### Scenario:

A customer support department needs an AI assistant to handle common inquiries automatically, troubleshoot product issues, and escalate complex requests.

### System Flow

Data Set Input: The system is fed a dataset of past customer support transcripts, product manuals, and troubleshooting guides.

Grounded Prompt Generation: The system constructs prompts tailored to specific topics—for instance, product return policies or connectivity issues—and merges them with actual user queries to simulate real-world customer interactions.

LLM Identification: The algorithm detects the “customer support” use case and selects LLMs known for conversational coherence and high context window for multi-turn dialogues.

Benchmark Configuration: Key benchmarks might center on accuracy (correct solutions), speed (fast response for low wait times), and cost (given high query volume).

GUI Display & Ordering: In the GUI, a support manager can select the “cost-effectiveness” metric to reorder LLMs. Models with moderate to high accuracy but low operational costs get ranked higher for pilot testing.

### Use Case 3: Legal Document Summarization

### Scenario:

A legal firm requires a system to rapidly summarize lengthy contracts, case files, or statutes to streamline case preparation.

### System Flow

Data Set Input: Large volumes of legal documents (contracts, past case rulings) are uploaded.

Grounded Prompt Generation: Prompts are built to highlight key clauses, obligations, or precedents relevant to a case.

LLM Identification: The system recognizes the “legal” domain and filters LLMs known for high language precision and domain-specific training.

Benchmark Configuration: The firm configures benchmarks emphasizing accuracy of summarization, trust & safety (avoiding disclosure of privileged information), and manual accuracy checks by paralegals.

GUI Display & Ordering: Users can reorder models based on how well they handle longer input tokens (large context windows) for extensive legal documents.

### Use Case 4: Marketing Content Generation

### Scenario:

A marketing team wants to generate blog posts, social media content, and product descriptions tailored to specific campaigns or target audiences.

### System Flow

Data Set Input: The system ingests style guides, brand guidelines, and existing marketing copy.

Grounded Prompt Generation: Prompts incorporate brand language, product features, and target demographics to ensure output matches marketing objectives.

LLM Identification: The matching algorithm detects a “marketing” use case and selects LLMs optimized for creative generation and style consistency.

Benchmark Configuration: The benchmark might track cost (since many posts may be generated), speed, and manual accuracy (human reviewers checking brand conformance).

GUI Display and Ordering: The marketing lead can select “creativity” or “generation quality” as a priority metric. The system reorders LLMs accordingly, highlighting those with the best track record for compelling text output.

### Use Case 5: Agent-Based Task Automation

### Scenario:

An organization implements autonomous agents to perform tasks such as scheduling meetings, booking travel, or analyzing reports with minimal human oversight.

### System Flow

Data Set Input: Relevant data about internal processes, calendars, travel policies, and third-party APIs are provided to the system.

Grounded Prompt Generation: Prompts ensure that the agent-based LLM knows the organizational constraints (e.g., budget caps, preferred vendors) and the user’s preferences.

LLM Identification: The system looks for models with robust “agent” capabilities, such as handling multi-step logic or using tools (APIs, databases) to fulfill requests.

Benchmark Configuration: Key metrics might include speed (real-time decision-making), trust and safety (avoiding policy violations), and manual accuracy checks in critical tasks (like budget approvals).

GUI Display and Ordering: A user can reorder the LLM list based on “agent-based action” performance or cost concerns. The system highlights LLMs that perform best in orchestrating multi-step commands accurately and securely.

### Use Case 6: Educational Content/Assessment Generator

### Scenario:

An e-learning platform wants to generate quizzes, explanations, and study guides for a range of topics, from math and science to literature.

### System Flow

Data Set Input: The system processes textbooks, lecture notes, and existing question banks.

Grounded Prompt Generation: It creates prompts that vary the level of difficulty, question format (multiple choice, essay), and subject matter according to the course.

LLM Identification: The “educational” use case triggers a filter for LLMs known for reliable fact retrieval and step-by-step explanations.

Benchmark Configuration: Desired benchmarks may include factual accuracy (veracity of the educational content), manual accuracy (teacher-provided corrections), and trust & safety (screening for inappropriate content).

GUI Display and Ordering: In the interface, an admin may select “high factual accuracy” as the main metric, so the system adjusts the LLM listing to prioritize models with proven educational or academic performance metrics.

These examples highlight various domains—from corporate knowledge management and customer support to legal summarization, marketing generation, agent-based tasks, and educational content creation—where the system’s ability to receive datasets, generate grounded prompts, benchmark multiple LLMs, and display a dynamically ordered GUI listing of LLMs for making a determination and selection of suitable LLMs for each use case.

### Example Clauses

Clause 1. A system comprising: one or more processors; and one or more non-transitory computer-readable media storing computer-executable instructions that, when executed, cause the one or more processors to perform operations comprising: receiving at least one data set associated with at least one use case; generating at least one grounded prompt based on the at least one data set for generating a sample response; in response to detection of the at least one grounded prompt of at least one selected element associated with the at least one use case, identifying, using an algorithm, a set of one or more LLMs that are applicable to the at least one use case based on the at least one data set; configuring at least one benchmark associated with the set of one or more LLMs to evaluate individual LLMs of the set of one or more LLMs; displaying in a Graphical User Interface (GUI), a listing of the set of one or more LLMs in accordance with an evaluation based on the at least one benchmark; and determining an order of the set of one or more LLMs in the GUI based on a selection of at least one selectable element configured in the GUI, wherein the at least one selectable element is mapped with the at least one benchmark to enable identifying of an LLM that is suitable for the at least one use case.

Clause 2. The system of clause 1, wherein the operations further comprise configuring the at least one benchmark by at least one of a manual evaluation function or an automatic evaluation function.

Clause 3. The system of clause 1, wherein the operations further comprise causing reordering of the order of the set of one or more LLMs to be associated with another selectable element to produce a different listing of the set of one or more LLMs.

Clause 4. The system of clause 3, wherein in response to producing the different listing of the set of one or more LLMs, enabling an identification of another LLM that is suitable for at least one use case and has been mapped in accordance with the another selectable element.

Clause 5. The system of clause 3, wherein reordering the order of the set of one or more LLMs in the GUI comprises: adjusting one or more selectable elements to change a weighting of criteria resulting in a different listing of the set of one or more LLMs for assisting in identification of a more suitable LLM for the at least one use case.

Clause 6. The system of clause 4, wherein the at least one benchmark associated with the set of one or more LLMs is configured based on at least one metric of a set of metrics comprising at least one of accuracy, cost, speed, or trust and safety associated with the at least one use case.

Clause 7. The system of clause 5, wherein the at least one benchmark based on at least one metric of accuracy is configured based on setting of an accuracy threshold and a set of sub-metrics comprising at least one sub-metric of instruction following, completeness, conciseness, or factuality associated with the at least one use case.

Clause 8. The system of clause 5 wherein the at least one benchmark based on at least one metric of trust and safety is configured based on a set of sub-metrics comprising at least one of safety, privacy, truthfulness, or CRM fairness.

Clause 9. The system of clause 5, wherein the at least one benchmark based on at least one metric of accuracy is configured based on setting of a point score in accordance with a point scale.

Clause 10. The system of clause 9, wherein the point score for the at least one metric of accuracy is configured by assigning one or more point values across multiple sub-metrics of accuracy and summing the one or more point values of each sub-metric of accuracy for a resulting total score to evaluate the at least one metric of accuracy for the at least one use case.

Clause 11. The system of clause 10, wherein the operations further comprise determining the point score for the at least one metric of trust and safety by assigning one or more point values across the multiple sub-metrics of trust and safety and summing the one or more point values of each sub-metric of trust and safety for the resulting total score to evaluate the at least one metric of trust and safety for the at least one use case.

Clause 12. One or more non-transitory computer-readable media storing instructions executable by one or more processors, wherein the instructions, when executed, cause the one or more processors to perform operations comprising: receiving at least one data set associated with at least one use case; generating at least one grounded prompt based on the at least one data set for generating a sample response; in response to detection of the at least one grounded prompt of at least one selected element associated with the at least one use case, identifying, using an algorithm, a set of one or more LLMs that are applicable to the at least one use case based on the at least one data set; configuring at least one benchmark associated with the set of one or more LLMs to evaluate individual LLMs of the set of one or more LLMs; displaying in a Graphical User Interface (GUI), a listing of the set of one or more LLMs in accordance with an evaluation based on the at least one benchmark; and determining an order of the set of one or more LLMs in the GUI based on a selection of at least one selectable element configured in the GUI, wherein the at least one selectable element is mapped with the at least one benchmark to enable identifying of an LLM that is suitable for the at least one use case.

Clause 13. The one or more non-transitory computer-readable media of clause 12, configuring the at least one benchmark by at least one of a manual evaluation function or an automatic evaluation function.

Clause 14. The one or more non-transitory computer-readable media of clause 12, wherein the operations further comprise causing reordering of the order of the set of one or more LLMs to be associated with another selectable element to produce a different listing of the set of one or more LLMs.

Clause 15. The one or more non-transitory computer-readable media of clause 14, wherein in response to producing the different listing of the set of one or more LLMs, enabling an identification of another LLM that is suitable for at least one use case and has been mapped in accordance with the another selectable element.

Clause 16. The one or more non-transitory computer-readable media of clause 15, wherein reordering of the set of one or more LLMs in the GUI comprises: adjusting one or more selectable elements to change a weighting of criteria resulting in a different listing of the set of one or more LLMs for assisting in identification of a more suitable LLM for the at least one use case.

Clause 17. The one or more non-transitory computer-readable media of clause 16, wherein the at least one benchmark based on at least one metric of accuracy is configured based on setting of an accuracy threshold and a set of sub-metrics comprising at least one sub-metric of instruction following, completeness, conciseness, or factuality associated with the at least one use case.

Clause 18. The one or more non-transitory computer-readable media of clause 16, wherein the at least one benchmark associated with the set of one or more LLMs is configured based on at least one metric of a set of metrics comprising at least one of accuracy, cost, speed, or trust and safety associated with the at least one use case.

Clause 19. The one or more non-transitory computer-readable media of clause 16, wherein the at least one benchmark based on at least one metric of trust and safety is configured based on a set of sub-metrics comprising at least one of safety, privacy, truthfulness, or CRM fairness.

Clause 20. A method comprising: receiving at least one data set associated with at least one use case; generating at least one grounded prompt based on the at least one data set for generating a sample response; in response to detection of the at least one grounded prompt of at least one selected element associated with the at least one use case, identifying, using an algorithm, a set of one or more LLMs that are applicable to the at least one use case based on the at least one data set; configuring at least one benchmark associated with the set of one or more LLMs to evaluate individual LLMs of the set of one or more LLMs; displaying in a Graphical User Interface (GUI), a listing of the set of one or more LLMs in accordance with an evaluation based on the at least one benchmark; and determining an order of the set of one or more LLMs in the GUI based on a selection of at least one selectable element configured in the GUI, wherein the at least one selectable element is mapped with the at least one benchmark to enable identifying of an LLM that is suitable for the at least one use case.

### Conclusion

While one or more examples of the techniques described herein have been described, various alterations, additions, permutations and equivalents thereof are included within the scope of the techniques described herein.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware software-based framework for training, processing, fine-tuning, or performing any other implementation steps. Furthermore, AI technology may include a hardware software-based framework that performs one or more functions, such as retrieving, generating, accessing, transmitting, etc. The AI technology may be implemented by a computer, including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to train the AI technology further. The AI technology may offer a variety of capabilities, including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train the output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a particular order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the one or more processors to perform operations comprising:
receiving at least one data set associated with at least one use case;
generating at least one grounded prompt based on the at least one data set for generating a sample response;
in response to detection of the at least one grounded prompt of at least one selected element associated with the at least one use case, identifying, using an algorithm, a set of one or more LLMs that are applicable to the at least one use case based on the at least one data set;
configuring at least one benchmark associated with the set of one or more LLMs to evaluate individual LLMs of the set of one or more LLMs;
displaying in a Graphical User Interface (GUI), a listing of the set of one or more LLMs in accordance with an evaluation based on the at least one benchmark; and
determining an order of the set of one or more LLMs in the GUI based on a selection of at least one selectable element configured in the GUI, wherein the at least one selectable element is mapped with the at least one benchmark to enable identifying of an LLM that is suitable for the at least one use case.

2. The system of claim 1, wherein the operations further comprise configuring the at least one benchmark by at least one of a manual evaluation function or an automatic evaluation function.

3. The system of claim 1, wherein the operations further comprise causing reordering of the order of the set of one or more LLMs to be associated with another selectable element to produce a different listing of the set of one or more LLMs.

4. The system of claim 3, wherein in response to producing the different listing of the set of one or more LLMs, enabling an identification of another LLM that is suitable for at least one use case and has been mapped in accordance with the another selectable element.

5. The system of claim 3, wherein reordering the order of the set of one or more LLMs in the GUI comprises:
adjusting one or more selectable elements to change a weighting of criteria resulting in a different listing of the set of one or more LLMs for assisting in identification of a more suitable LLM for the at least one use case.

6. The system of claim 4, wherein the at least one benchmark associated with the set of one or more LLMs is configured based on at least one metric of a set of metrics comprising at least one of accuracy, cost, speed, or trust and safety associated with the at least one use case.

7. The system of claim 5, wherein the at least one benchmark based on at least one metric of accuracy is configured based on setting of an accuracy threshold and a set of sub-metrics comprising at least one sub-metric of instruction following, completeness, conciseness, or factuality associated with the at least one use case.

8. The system of claim 5, wherein the at least one benchmark based on at least one metric of trust and safety is configured based on a set of sub-metrics comprising at least one of safety, privacy, truthfulness, or CRM fairness.

9. The system of claim 5, wherein the at least one benchmark based on at least one metric of accuracy is configured based on setting of a point score in accordance with a point scale.

10. The system of claim 9, wherein the point score for the at least one metric of accuracy is configured by assigning one or more point values across multiple sub-metrics of accuracy and summing the one or more point values of each sub-metric of accuracy for a resulting total score to evaluate the at least one metric of accuracy for the at least one use case.

11. The system of claim 10, wherein the operations further comprise determining the point score for the at least one metric of trust and safety by assigning the one or more point values across the multiple sub-metrics of trust and safety and summing the one or more point values of each sub-metric of trust and safety for the resulting total score to evaluate the at least one metric of trust and safety for the at least one use case.

12. One or more non-transitory computer-readable media storing instructions executable by one or more processors, wherein the instructions, when executed, cause the one or more processors to perform operations comprising:
receiving at least one data set associated with at least one use case;
generating at least one grounded prompt based on the at least one data set for generating a sample response;
in response to detection of the at least one grounded prompt of at least one selected element associated with the at least one use case, identifying, using an algorithm, a set of one or more LLMs that are applicable to the at least one use case based on the at least one data set;
configuring at least one benchmark associated with the set of one or more LLMs to evaluate individual LLMs of the set of one or more LLMs;
displaying in a Graphical User Interface (GUI), a listing of the set of one or more LLMs in accordance with an evaluation based on the at least one benchmark; and
determining an order of the set of one or more LLMs in the GUI based on a selection of at least one selectable element configured in the GUI, wherein the at least one selectable element is mapped with the at least one benchmark to enable identifying of an LLM that is suitable for the at least one use case.

13. The one or more non-transitory computer-readable media of claim 12, configuring the at least one benchmark by at least one of a manual evaluation function or an automatic evaluation function.

14. The one or more non-transitory computer-readable media of claim 12, wherein the operations further comprise causing reordering of the order of the set of one or more LLMs to be associated with another selectable element to produce a different listing of the set of one or more LLMs.

15. The one or more non-transitory computer-readable media of claim 14, wherein in response to producing the different listing of the set of one or more LLMs, enabling an identification of another LLM that is suitable for at least one use case and has been mapped in accordance with the another selectable element.

16. The one or more non-transitory computer-readable media of claim 15, wherein reordering of the set of one or more LLMs in the GUI comprises:
adjusting one or more selectable elements to change a weighting of criteria resulting in a different listing of the set of one or more LLMs for assisting in identification of a more suitable LLM for the at least one use case.

17. The one or more non-transitory computer-readable media of claim 16, wherein the at least one benchmark based on at least one metric of accuracy is configured based on setting of an accuracy threshold and a set of sub-metrics comprising at least one sub-metric of instruction following, completeness, conciseness, or factuality associated with the at least one use case.

18. The one or more non-transitory computer-readable media of claim 16, wherein the at least one benchmark associated with the set of one or more LLMs is configured based on at least one metric of a set of metrics comprising at least one of accuracy, cost, speed, or trust and safety associated with the at least one use case.

19. The one or more non-transitory computer-readable media of claim 16, wherein the at least one benchmark based on at least one metric of trust and safety is configured based on a set of sub-metrics comprising at least one of safety, privacy, truthfulness, or CRM fairness.

20. A method comprising:
receiving at least one data set associated with at least one use case;
generating at least one grounded prompt based on the at least one data set for generating a sample response;
in response to detection of the at least one grounded prompt of at least one selected element associated with the at least one use case, identifying, using an algorithm, a set of one or more LLMs that are applicable to the at least one use case based on the at least one data set;
configuring at least one benchmark associated with the set of one or more LLMs to evaluate individual LLMs of the set of one or more LLMs;
displaying in a Graphical User Interface (GUI), a listing of the set of one or more LLMs in accordance with an evaluation based on the at least one benchmark; and
determining an order of the set of one or more LLMs in the GUI based on a selection of at least one selectable element configured in the GUI, wherein the at least one selectable element is mapped with the at least one benchmark to enable identifying of an LLM that is suitable for the at least one use case.
